(19) United States
(12) Patent Application Publication
(10) Pub. No.: US 2023/0257047 A1
(43) Pub. Date: Aug. 17, 2023

(54) REMOVABLE SEAT ASSEMBLY

(71) Applicant: Arctic Cat Inc., Thief River Falls, MN (US)

(72) Inventors: Guy L. Sibilleau, Roseau, MN (US); Christian Ressler, Thief River Falls, MN (US)

(21) Appl. No.: 18/084,868

(22) Filed: Dec. 20, 2022

Related U.S. Application Data
(60) Provisional application No. 63/310,983, filed on Feb. 16, 2022.
(60) Provisional application No. 63/350,553, filed on Jun. 9, 2022.
(60) Provisional application No. 63/404,682, filed on Sep. 8, 2022.
(60) Provisional application No. 63/404,655, filed on Sep. 8, 2022.

(51) Int. Cl. B62J 1/08; B62J 1/00; B62J 11/19

(52) U.S. Cl. CPC B62J 1/08; B62J 1/005; B62J 11/19

(57) ABSTRACT

According to one or more aspects of the present disclosure, a removable seat assembly is provided comprising a first mounting feature engageable with the tunnel of a snow vehicle, and optionally a second mounting feature engageable with the tunnel of the snow vehicle. The first mounting feature may automatically engage the tunnel upon engagement of the second mounting feature with the tunnel. The seat assembly may comprise a frame base, a riser defining a chamber therein positioned on the frame base, a seat back frame, and an arm rest secured to the frame base and the seat back frame.

### CROSS-REFERENCE TO RELATED APPLICATION

This application claims benefit of U.S. Provisional Application No. 63/310,983 filed on Feb. 16, 2022, U.S. Provisional Application No. 63/350,553 filed on Jun. 9, 2022, U.S. Provisional Application No. 63/404,682 filed on Sep. 8, 2022, and U.S. Provisional Application No. 63/404,655 filed on Sep. 8, 2022. The disclosures of the above applications are incorporated herein by reference in their entirety.

### BACKGROUND

Snowmobiles are popular land vehicles used as transportation vehicles or as recreational vehicles in cold and snowy conditions. Generally, snowmobiles are available for various applications such as deep snow, high performance, luxury touring, and trail riding, for example. In general, a snowmobile has a chassis on or around which the various components of the snowmobile are assembled. Typical snowmobiles include one or more skis for steering, a seat, handlebars, and an endless track for propulsion mounted to a central chassis. The engine drives a ground-engaging endless track disposed in a longitudinally extending drive tunnel. One or more skis serve to facilitate steering as well as to provide flotation of the front of the snowmobile over the snow in which it is operated. A handlebar assembly, positioned forward of the seat, is operatively linked to the skis for steering the snowmobile. The skis may be pivoted to steer the snowmobile, for example, by turning the handlebars. The snowmobile also includes a footrest/running boards for the driver while riding. The driver typically straddles the seat with one leg on each side of the seat.

### SUMMARY

According to one or more aspects of the present disclosure, a removable seat assembly comprising a seat frame, the seat frame including a frame base including a front member and a rear member, the front member and the rear member secured together by one or more base brackets, a seat back frame coupled to the rear support member, an arm rest comprising a rear support structure coupled to the seat back frame, and a front support structure coupled to the front member. The removable seat assembly further comprising a seat riser positioned on the frame base, wherein the arm rest provides a first structural support to transfer a load between the front member and the rear member.

According to one or more aspects of the present disclosure, a removable seat assembly, comprising a seat frame including a frame base, a seat riser positionable on a top panel of a snowmobile tunnel, the seat riser defining a chamber therein, an upper surface of the seat riser defining an opening to the chamber, a seat removably secured to the seat riser, the seat positioned on the upper surface of the seat riser to cover the opening, and a mounting feature removably secured to the snowmobile tunnel.

According to one or more aspects of the present disclosure, a snowmobile seat comprising a seat frame, the seat frame comprising a frame base, a seat back frame, and a front cast sleeve. The front cast sleeve comprising a front channel configured to receive a front fastener. The snowmobile further comprising a quick attachment member coupled to the frame base, wherein the quick attachment member is removably secured to an attachment base, and the attachment base is secured to a tunnel of a snowmobile, the tunnel of the snowmobile comprising the front fastener.

According to one or more aspects of the present disclosure, a method of assembling a seat comprising providing a seat frame comprising a frame base, a seat back frame, a front cast sleeve, and a rear cast sleeve, inserting the seat back frame through a plastic housing, positioning the plastic housing on the frame base, inserting a first hand grip comprising a first rear structural support and a first frontal structural support into the seat frame, wherein the first frontal structural support is inserted into the front cast sleeve; and inserting a second hand grip comprising a second rear structural support and a second frontal structural support into the seat frame, wherein the second frontal structural support is inserted into the front cast sleeve.

According to one or more aspects of the present disclosure, a removable seat assembly comprising a frame positionable on a top panel of a snowmobile tunnel, a seat positioned on the frame, and a first mounting feature positionable along a sidewall of the tunnel when the frame is positioned on the top panel to removably engage one or more mounting features on or in the tunnel sidewall. The removable seat assembly further comprising a second mounting feature positionable along the top panel when the frame is positioned on the top panel to removably engage one or more mounting features positioned on or in the top panel

According to one or more aspects of the present disclosure, a removable seat assembly comprising a base frame, a seat riser positioned on the base frame, the seat riser defining a chamber therein, a seat positioned on the riser, a seat back frame secured to the base frame, the seat back frame including a first end positioned in the chamber and secured to the base frame, and a second end positioned outside of the chamber rearward of the seat, an arm rest including a front support structure and a rear support structure, the rear support structure positioned in the chamber and secured to the seat back frame, and the front support structure positioned outside of the chamber and secured to the base frame.

According to one or more aspects of the present disclosure, a removable seat assembly comprising a riser positionable on a top panel of a snowmobile tunnel, the riser defining a chamber therein, and an upper surface of the riser defines an opening to the chamber, a seat removably securable to the riser, the seat is positioned on the upper surface of the riser to close the opening when the seat is secured to the riser, and a mounting feature that is removably securable to the tunnel to removably secure the riser thereto.

### BRIEF DESCRIPTION OF THE DRAWINGS

This written disclosure describes illustrative embodiments that are non-limiting and non-exhaustive. Reference is made to illustrative embodiments that are depicted in the figures, in which:

FIG. 1 illustrates a side view of a snowmobile, according to some embodiments.

FIG. 2 illustrates a perspective of a snowmobile, according to some embodiments.

FIG. 3 illustrates a top view of a snowmobile, according to some embodiments.

FIG. 4 illustrates a front view of a snowmobile, according to some embodiment.

FIG. 5 illustrates a right side view of a snowmobile with portions of the engine cover, fuel tank, and seat removed, according to some embodiments.

FIG. 6 illustrates a left side perspective view of the snowmobile including the fuel tank, seat frame, and rear panel, according to some embodiments.

FIG. 7 illustrates a top side perspective view of the fuel tank, the seat frame, and the rear panel, according to some embodiments.

FIG. 8 illustrates a rear perspective view of the fuel tank, the seat frame, and the rear panel, according to some embodiments.

FIG. 9 illustrates a top view of the fuel tank and the rear panel, according to some embodiments.

FIG. 10 illustrates a bottom view of the seat frame, according to some embodiments.

FIG. 11 illustrates a left side perspective view of the fuel tank attached to the frame, according to some embodiments.

FIG. 12 illustrates a rear perspective view of the fuel tank attached to the frame, according to some embodiments.

FIG. 13 illustrates a side cross-section view of the fuel tank, according to some embodiments.

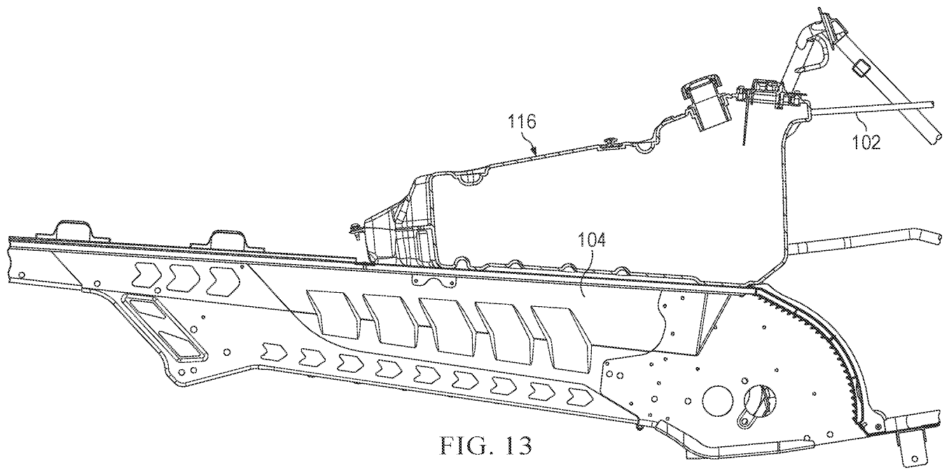

FIG. 14 illustrates a top cross-section view of the fuel tank, according to some embodiments.

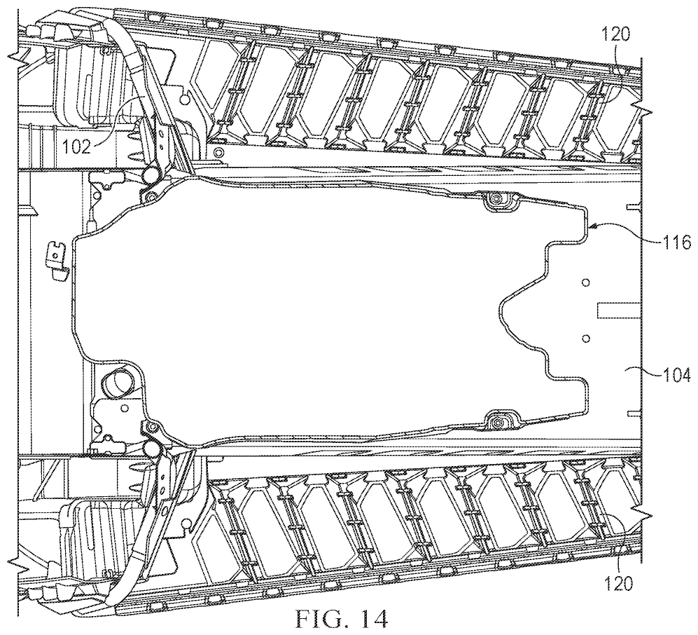

FIG. 15 illustrates a right side view of the fuel tank, according to some embodiments.

FIG. 16 illustrates a top view of the fuel tank, according to some embodiments.

FIG. 17 illustrates a top perspective view of the fuel tank, according to some embodiments.

FIG. 18 illustrates a front view of the fuel tank, according to some embodiments.

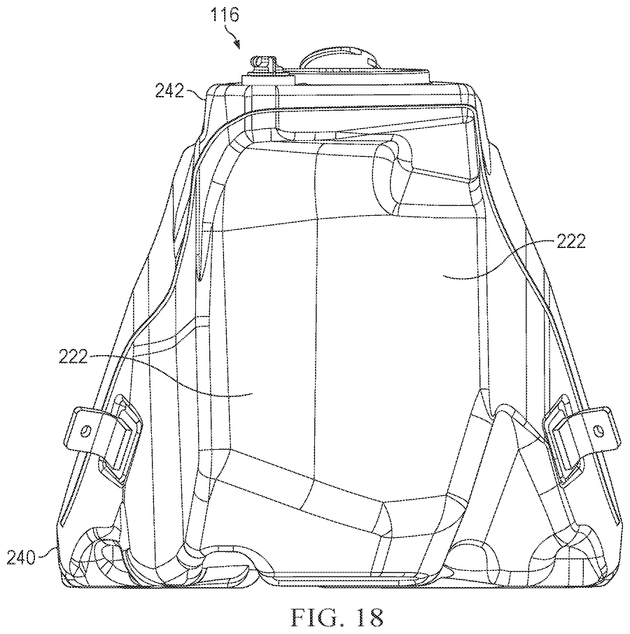

FIG. 19 illustrates a rear view of the fuel tank, according to some embodiments.

FIG. 20 illustrates a bottom view of the fuel tank, according to some embodiments.

FIG. 21 illustrates close-up detail view of the fuel tank attachment to the tunnel, according to some embodiments.

FIG. 22 illustrates a top view of a battery installed in a battery compartment formed between the fuel tank, the seat frame, and the rear panel, according to some embodiments.

FIG. 23 illustrates a bottom view the battery installed in the battery compartment and battery cables routed through a passageway in the fuel tank, according to some embodiments.

FIG. 24 illustrates close-up detail view of the rear panel attachment to the fuel tank, according to some embodiments.

FIG. 25 illustrates a bottom view of the rear panel, according to some embodiments.

FIG. 26 illustrates a front view of the rear panel, according to some embodiments.

FIG. 27 illustrates a rear view of the rear panel, according to some embodiments.

FIG. 28 illustrates a left side view of the rear panel, according to some embodiments.

FIG. 29 illustrates a perspective view of the removable seat secured to the snowmobile, according to some embodiments.

FIG. 30A illustrates a perspective view of a seat frame of the removable seat, according to some embodiments.

FIG. 30B illustrates a right side view of the seat frame of the removable seat, according to some embodiments.

FIG. 30C illustrates a top view of the seat frame of the removable seat, according to some embodiments.

FIG. 30D illustrates a front view of the seat frame of the removable seat, according to some embodiments.

FIG. 31 illustrates an exploded perspective view of the seat frame, according to some embodiments.

FIG. 32 illustrates an exploded perspective view of the seat frame and a seat riser, according to some embodiments.

FIG. 33 illustrates an exploded bottom view of the seat frame and the seat riser, according to some embodiments.

FIG. 34 illustrates a cross-sectional isometric view of the seat frame and seat riser, according to some embodiments.

FIG. 35 illustrates a perspective view of the tunnel and a reinforcement bracket, and seat mounting features according to some embodiments.

FIG. 36 illustrates a right side view of the seat frame positioned on top of the tunnel and engaged with the seat mounting features positioned on the tunnel sidewall, according to some embodiments.

FIG. 37 illustrates a left side view of an attachment member, according to some embodiments.

FIG. 38 illustrates a perspective view of an attachment base for the attachment member of FIG. 37, according to some embodiments.

FIG. 39A illustrates a cross-sectional right side view of the attachment member with a pin deployed to secure the attachment member to the attachment base, according to some embodiments.

FIG. 39B illustrates a cross-sectional right side view of the attachment member with the pin retracted to allow for removal of the attachment member from the attachment base, according to some embodiments.

FIG. 39C illustrates an isometric view of the attachment member housing with mounting holes, according to some embodiments.

FIG. 40 illustrates a right side view of forward and rearward seat frame mounting features and the housing of the attachment member secured to the seat frame, according to some embodiments.

FIG. 41 illustrates a right side view of the seat frame mounting features engaged with the tunnel mounting features, according to some embodiments.

FIG. 42 illustrates a right side view of the seat frame mounting features removed from the tunnel mounting features, according to some embodiments.

FIG. 43 illustrates a bottom isometric view of the seat frame and seat riser mounted to the tunnel, according to some embodiments.

FIG. 44 illustrates a perspective view of the attachment member secured to the attachment base, according to some embodiments.

FIG. 45 illustrates a front view of the seat riser, according to some embodiments.

FIG. 46 illustrates a cross-sectional right side view of the seat and the seat riser, according to some embodiments.

FIG. 47 illustrates a bottom cross-sectional view of the electrical connection port, according to some embodiments.

FIG. 48 illustrates a bottom view of the seat riser, according to some embodiments.

FIG. 49 illustrates an isometric bottom view of the seat riser, according to some embodiments.

FIG. 50 illustrates an isometric view of snowmobile tunnel with an attachment member with the seat riser removed, according to some embodiments.

FIG. 51A illustrates a perspective view of the electrical port in the interior compartment, according to some embodiments.

FIG. 51B illustrates a perspective view of the electrical port in the interior compartment, according to some embodiments.

FIG. 52 illustrates an isometric view of an electrical port heat element disposed in the seat riser, according to some embodiments.

FIG. 53 illustrates a perspective view of a seat bottom on the seat riser, according to some embodiments.

FIG. 54 illustrates a perspective view of a seat bottom on the seat riser, according to some embodiments.

FIG. 55 illustrates an isometric bottom view of a seat bottom, according to some embodiments.

FIG. 56 illustrates an isometric view of a seat assembly including wind panel, according to some embodiments.

FIG. 57 illustrates an isometric view of a controller and the wind panel secured to the seat frame of the removable seat, according to some embodiments.

### DETAILED DESCRIPTION

Embodiments of the present disclosure describe a removable seat assembly. The removable seat assembly may include one or more features for selectively securing the seat assembly to an off-road vehicle that may include, but is not limited to, a snowmobile.

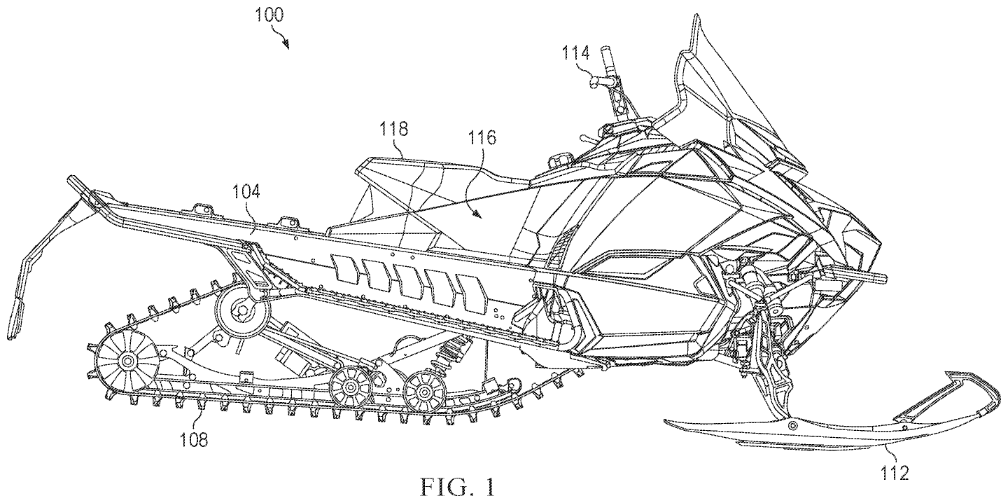

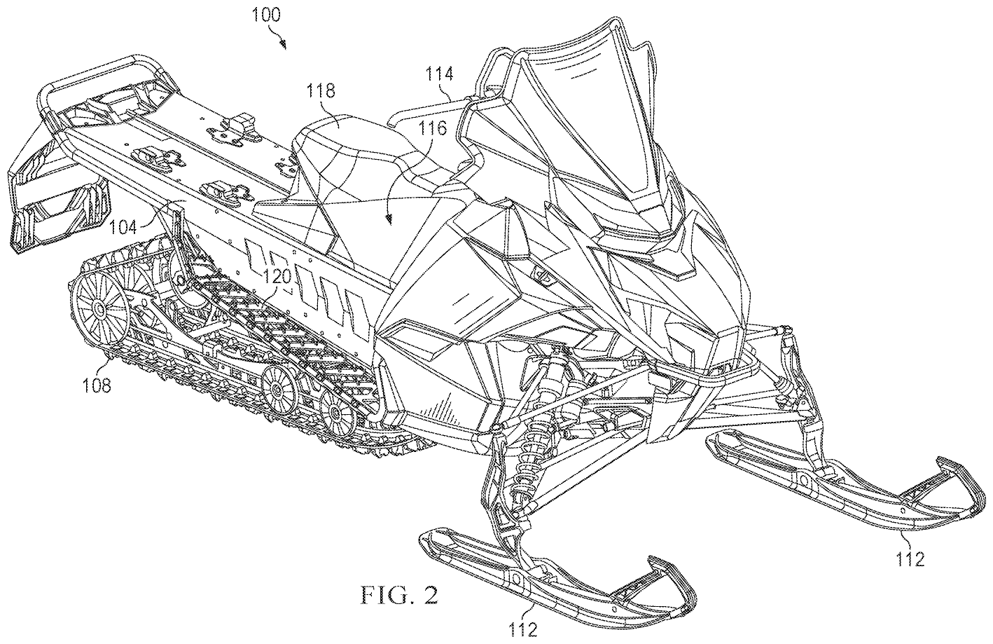

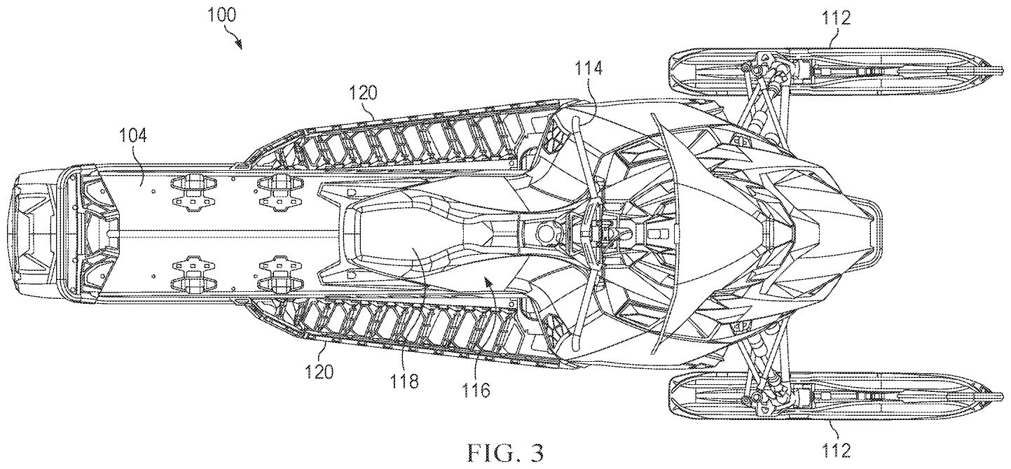

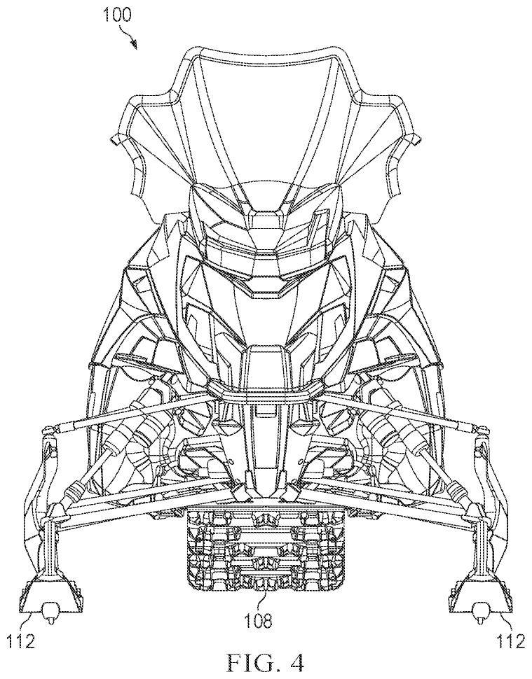

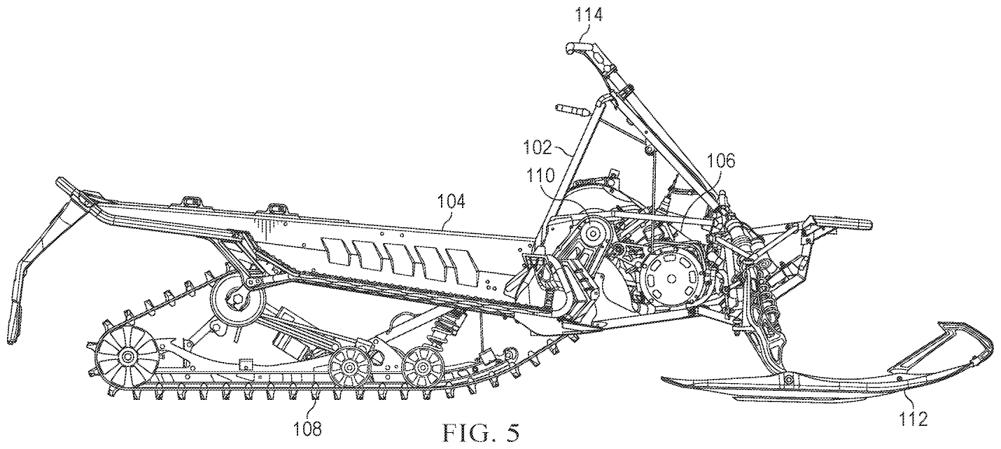

In a non-limiting example, the snowmobile 100 is generally shown in FIGS. 1-5 and may include a chassis 102, a tunnel 104, a powerplant 106, e.g., an electric motor or an internal combustion engine, attached to the chassis 102, a drive track 108 disposed within the tunnel 104, and a drivetrain 110 configured to provide motive power from the powerplant 106 to the drive track 108. The snowmobile further includes skis 112 operably connected to handlebars 114 that are used to turn the snowmobile 100 and running boards 120 that provide a footrest for the driver's feet.

The snowmobile 100 further includes an energy storage feature 116, e.g., a battery pack or a fuel tank depending on powerplant type, which is attached to the chassis 102 and the tunnel 104 of the snowmobile. The snowmobile 100 also includes a seat 118 configured to accommodate a snowmobile driver that is mounted solely to the energy storage feature 116. The seat 118 is further described in U.S. Provisional Patent App. No. 63/350,553 filed on Jun. 9, 2022, entitled “Snowmobile With Seat And Gas Tank Assembly,” U.S. Provisional Patent App. No. 63/404,682 filed on Sep. 8, 2022, entitled “Snowmobile With Seat Assembly,” and U.S. patent application Ser. No. 17/988,111 filed Nov. 16, 2022, and entitled “Fuel Tank And Seat Assembly For A Vehicle,” which are hereby incorporated by reference in their entirety.

The non-limited example of a snowmobile 100 presented herein is directed to an internal combustion engine powered snowmobile and so will refer to the power train as “the engine 106” and the energy storage feature as “the fuel tank 116”. Other examples of electric powered snowmobiles having an electric motor and battery pack that are embodiments of the inventive features may also be envisioned.

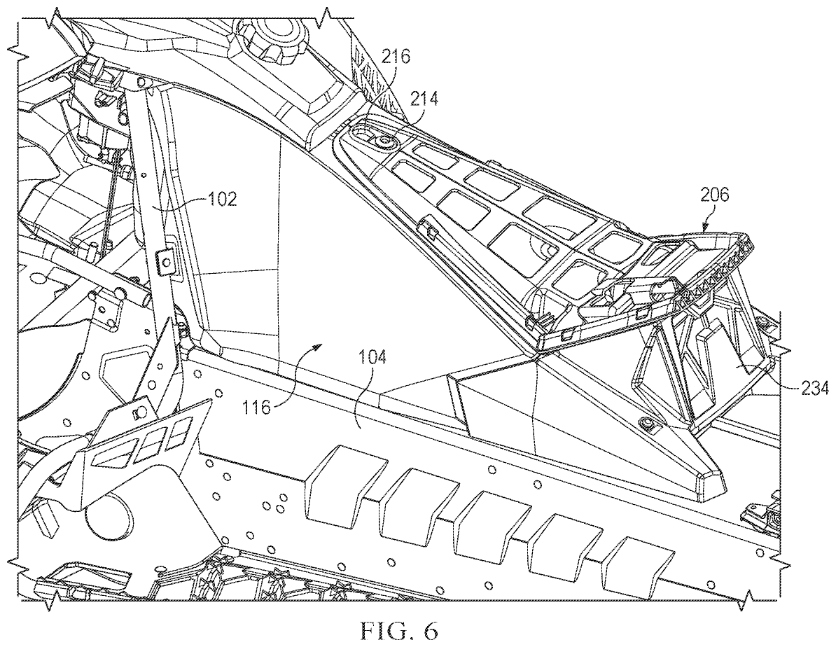

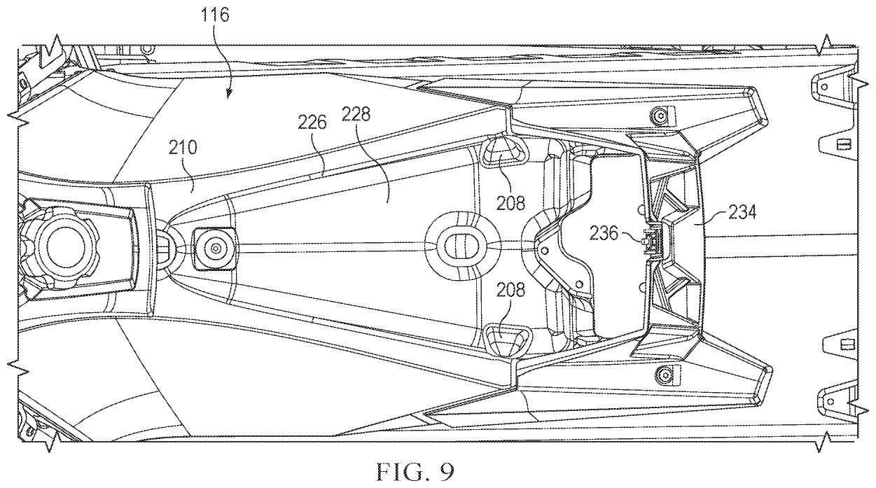

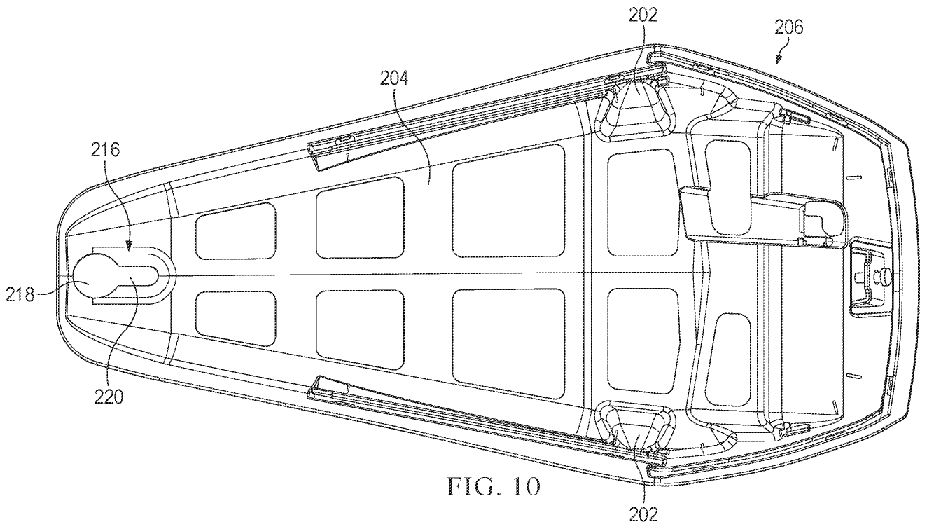

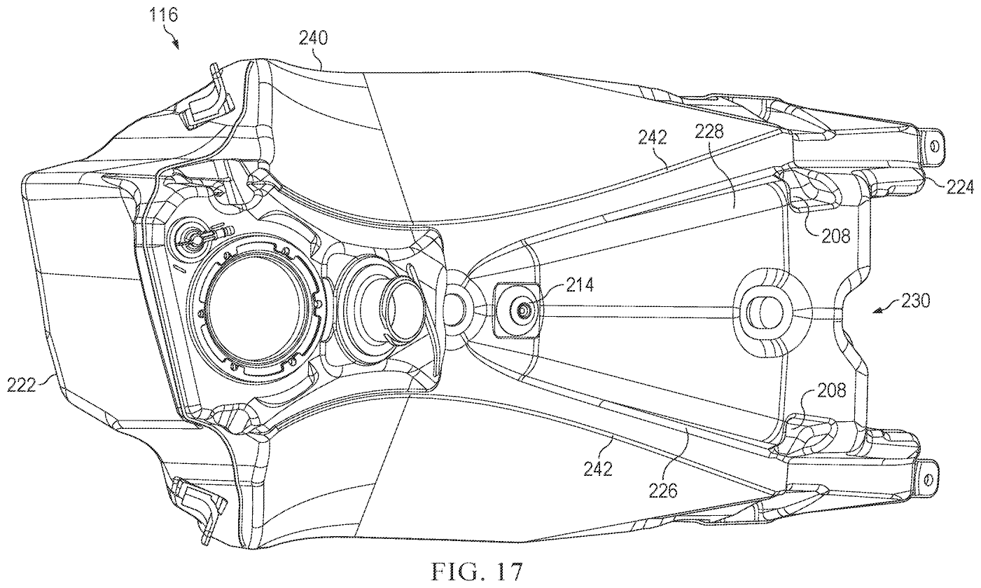

As shown in FIGS. 6-8, the seat 118 is mounted to the fuel tank 116 by a plurality of mounting devices that include engagement members that may be in the form of two trapezoidal projections 202 on the lower surface 204 of the seat 118, particularly the seat frame 206 as shown in FIG. 10. These projections 202 are received within two engagement members such as trapezoidal pockets 208 on an upper surface 210 of the fuel tank 116 that are shown in FIGS. 9, 15-17, and 19. The projections 202 and pockets 208 have a generally trapezoidal shape in at least two axes, vertical and lateral. The projections 202 and pockets 208 are vertically tapered with their upper portions being wider than their lower portions. The projections 202 and pockets 208 are also laterally tapered with their mesial portions being wider than their distal portions. The projections 202 are located near outboard edges of the seat frame 206 and the pockets 208 are located near outboard edges of the fuel tank 116. It is to be understood that the shape or location of the engagement members illustrated is not limiting, and other shapes and configurations may be used. For example, the fuel tank may be provided with projections and the frame may be provided with pockets for receiving the projections.

As further illustrated in FIGS. 6-8, the seat frame 206 may include a first portion 201 and a second portion 205. The first portion 201 of the seat frame 206 may be configured to rest against the upper surface 210 of the fuel tank 116. The second portion 205 of the seat frame 206 may be configured to extend away from the upper surface 210 of the fuel tank 116 and rest against a rear panel 234. In some embodiments, the second portion 205 of the seat frame 206 may extend from the rear portion of the fuel tank 116, over a rearward facing chamber 230, and rest against the rear panel 234. The first portion 201 of the seat frame 206 may include a continuous descending slope from the front to the rear, i.e., the first portion 201 descends toward the tunnel 104 as the distance from the front end of the snowmobile 100 increases. In contrast, the second portion 205 of the seat frame 206 may include a continuous ascending slope from front to rear, i.e., the second portion 205 ascends away from the tunnel 104 as the distance from the front end of the snowmobile 100 increases (see e.g., FIGS. 6-8). The first portion 201 and the second portion 205 form a v-shape near the center of the seat frame 206.

The fuel tank 116 and the rear panel 234 may share the rider load, or in other words, the rider's weight may be distributed between the fuel tank 116 and the rear panel 234. For instance, the forwardmost portion of the rear panel 234 extends underneath the fuel tank 116 and underneath the first portion 201 of the seat frame 205. Therefore, a rider load disposed on the first portion 201 of the seat frame 206 will be distributed between the fuel tank 116 and the rear panel 234.

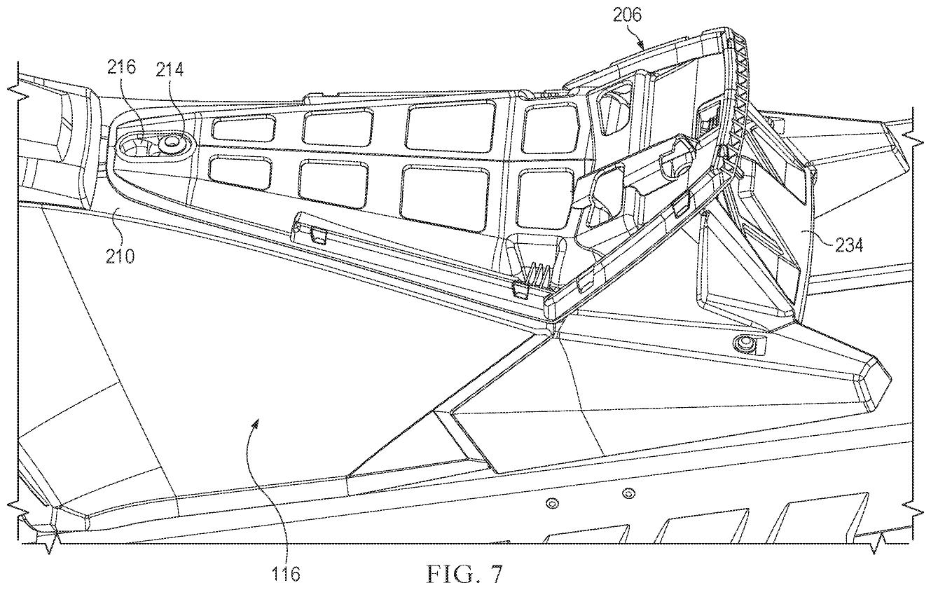

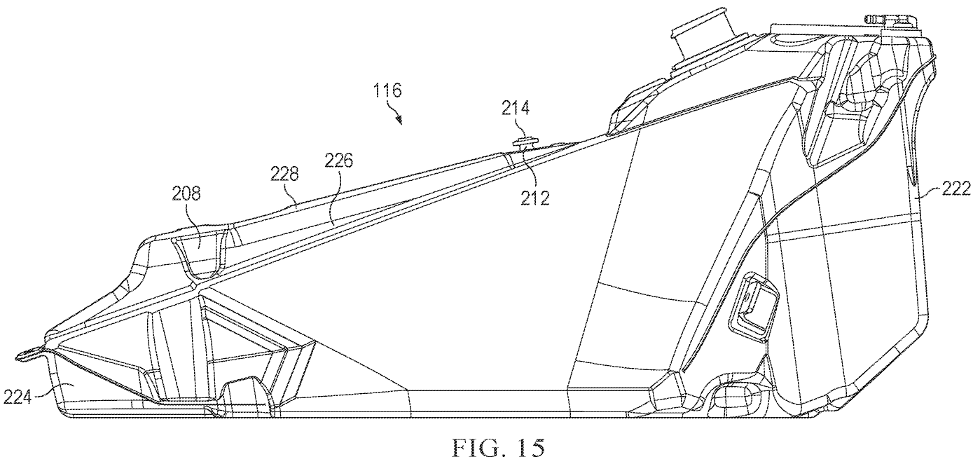

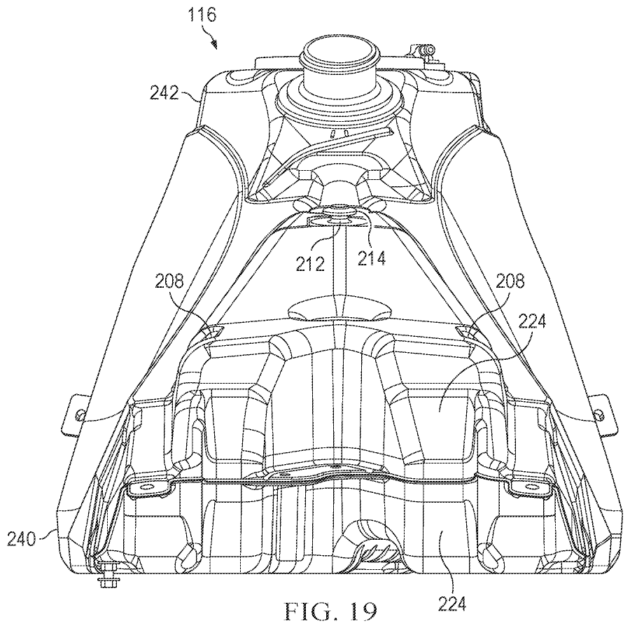

The plurality of mounting devices also includes a pillar 212, shown in FIGS. 15 and 19, mounted along a centerline of the fuel tank 116 and standing proud from the upper surface 210 of the fuel tank 116. The pillar 212 is capped by a disc 214 shown in FIGS. 6, 7, 15-17, and 19 having a larger diameter than the pillar 212. The pillar 212 and disc 214 are received within a keyhole-shaped opening 216 in the lower surface of the seat frame 206. As shown in FIG. 10, a forward potion of the keyhole-shaped opening 216 has a round portion 218 and a slot portion 220 interconnected thereto that extends rearwardly from the round portion 218. The pillar 212 and the disc 214 are received within the round portion 218 and the seat frame 206 is then moved forward to secure the seat frame 206 to the fuel tank 116 by sliding the pillar 212 into the slot portion 220 and disposing the seat frame 206 between the disc 214 and the upper surface 210 of the fuel tank 116 as illustrated in FIG. 7. As the seat frame 206 is moved forwardly, the projections 202 are aligned with and may be received within the pockets 208. The pillar 212 and disc 214 assembly and the pockets 208 are arranged on the upper surface 210 of the fuel tank 116 in a generally isosceles triangular configuration.

In alternative embodiments, the lower surface 204 of the seat frame 206 may define a keyhole-shaped opening in which the slot portion is forward of the round portion (not shown). After the disc 214 and pillar 212 are received within the round portion of this alternative keyhole-shaped opening, the seat frame 206 is then moved rearwardly to secure the seat frame 206 to the fuel tank 116.

The projections 202 and pockets 208 allow longitudinal and lateral positional tolerance for these mounting devices that may accommodate dimensional variations caused by manufacturing processes used to form the fuel tank 116, e.g., blow molding.

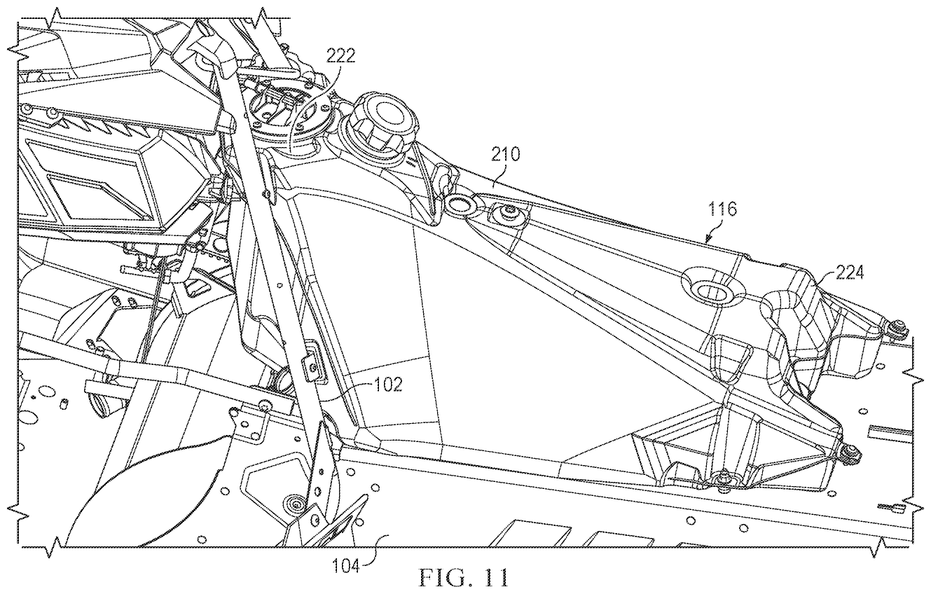

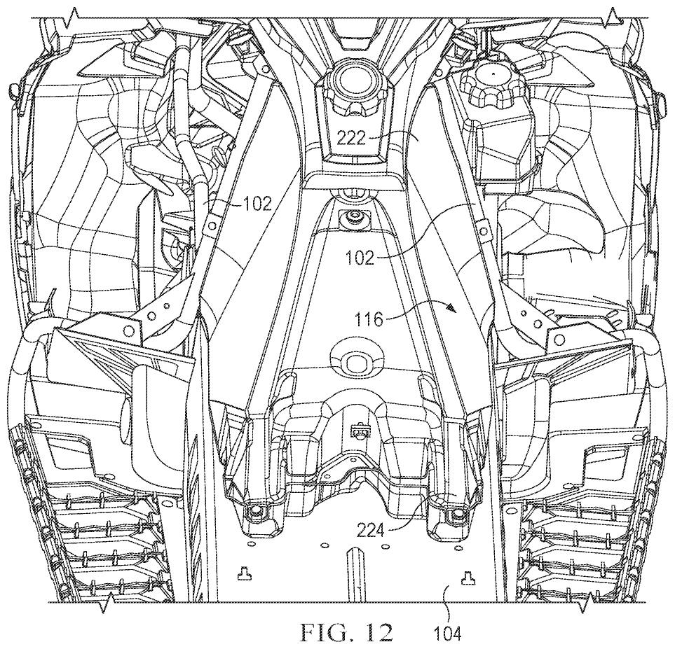

The upper surface 210 extends from a forward portion 222 downward to a rearward portion 224 as shown in FIGS. 11 and 12. The upper surface 210 includes a first trapezoidal tier 226 with first outboard sides extending from the rearward portion 224 and converging toward the forward portion 222 and a second trapezoidal tier 228 extending upward from the first trapezoidal tier 226 as shown in FIGS. 9 and 15-17. The second trapezoidal tier 228 has second outboard sides extending from the rearward portion 224 and converging toward the forward portion 222 as also shown in FIG. 9. The second outboard sides of the second trapezoidal tier 228 are positioned inboard of the first outboard sides of the first trapezoidal tier 226. The pockets 208 are positioned along the outboard sides of the second trapezoidal tier 228 nearer the rearward portion 224 of the fuel tank 116 and are positioned outboard and opposite each other in relation to a centerline of the upper surface 210. The pillar 212 and the disc 214 are positioned along the centerline of the upper surface 210 and are located nearer the forward portion 222 of the fuel tank 116.

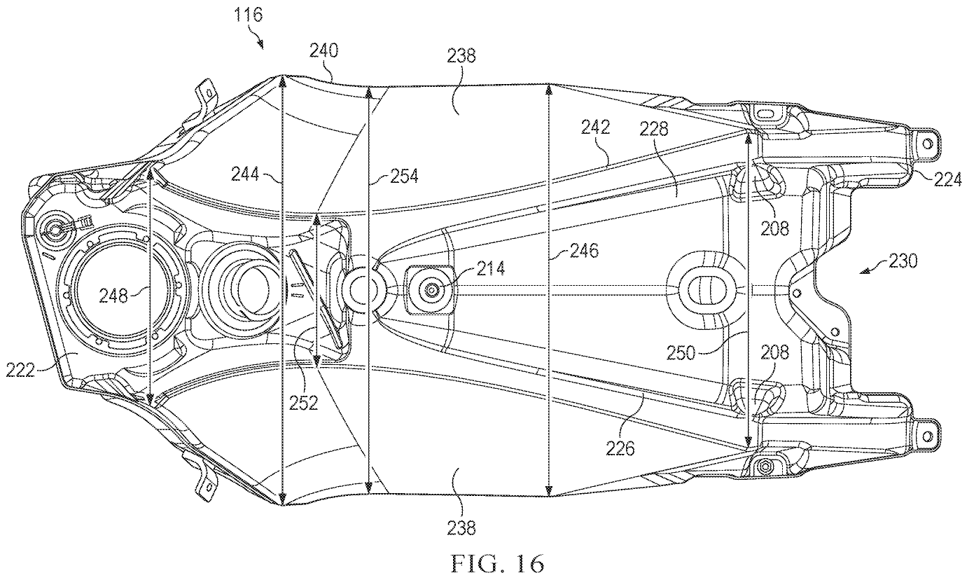

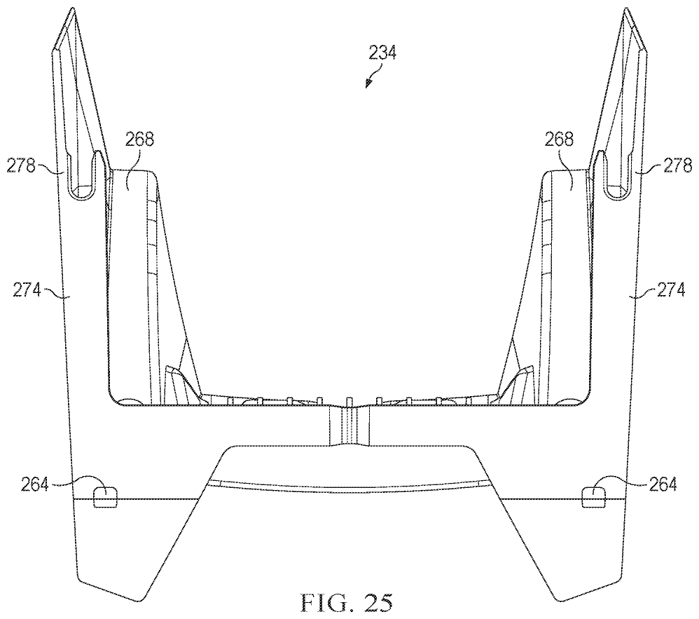

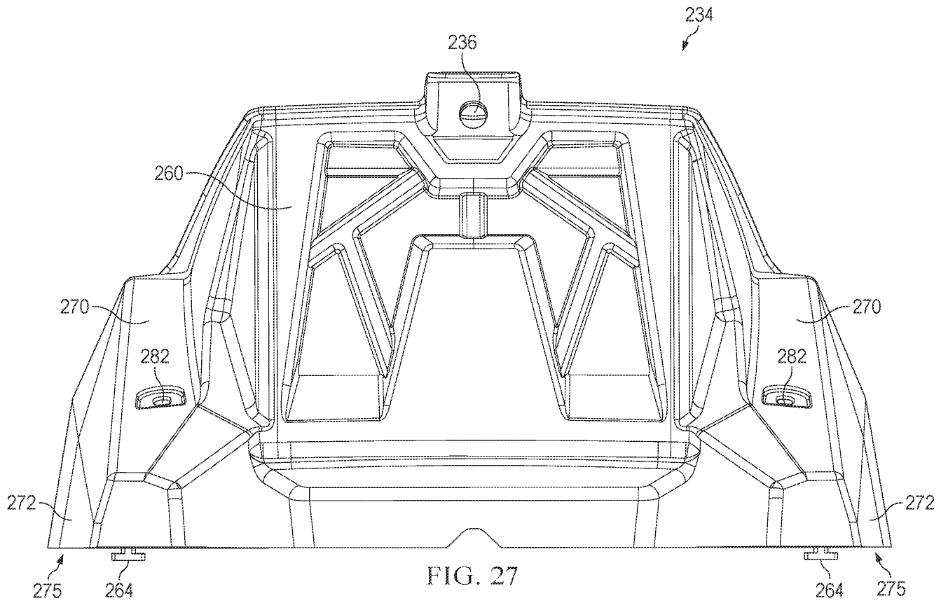

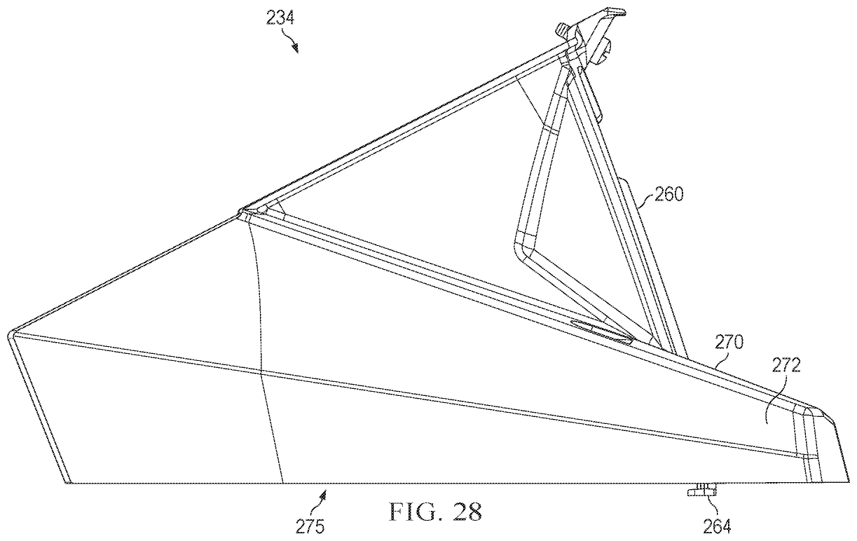

As shown in FIGS. 16, 17, 20, 22, and 23, the rearward portion 224 of the fuel tank 116 defines the rearward facing chamber 230 generally in the form of an open rectangular slot that is configured to enclose a starter battery 232 or other items. The rear panel 234 shown in FIGS. 6-9 and 22-28 slidingly and removably engages the rearward portion 224 of the fuel tank 116 to enclose the rearward facing chamber 230. In some embodiments, the rear panel 234 may be made of plastic or other insulating materials. Thus, the inner surfaces of the rearward facing chamber 230 may be non-metal and/or non-conducting material. The rearward facing chamber 230 may space the starter battery 232 from the tunnel 104.

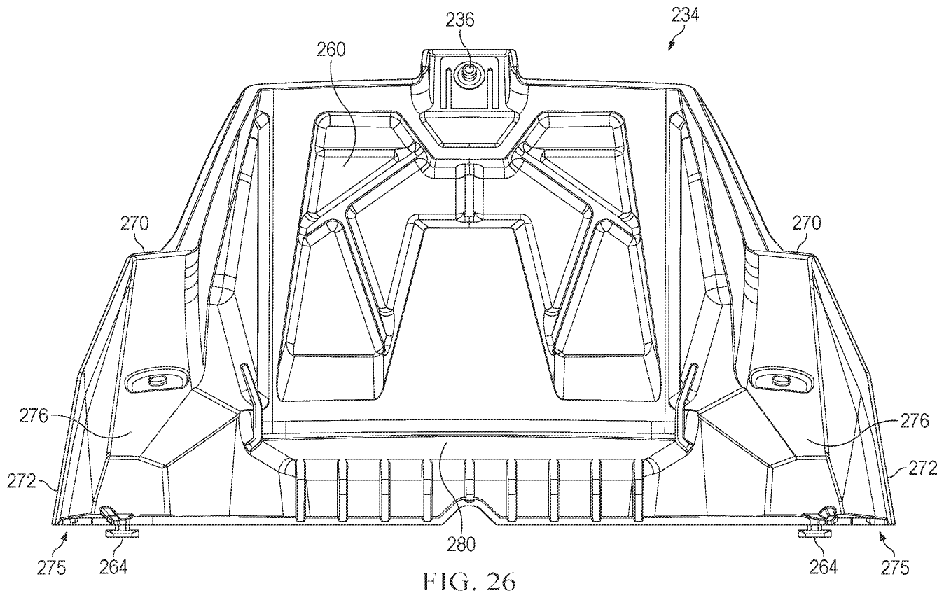

As shown in FIGS. 26-28, the rear panel 234 includes a rear wall 260 extending between two outboard legs 275 that slidingly receive the portions 224 extending rearward from the fuel tank 116. The outboard legs 275 include a lower wall 274 positionable on the upper surface of the tunnel 104, side walls 272 and an upper wall 270 that define a chamber 276 for receiving the portions 224 therein. An interior surface 268 of the upper wall 270 is slanted to rest on the sloped surface of the portions 224 when installed on the fuel tank 116 so that the forwardmost portion of the upper wall 270 of the leg 275 is positioned adjacent the pocket 208. The outboard sides of the portions 224 may be recessed with respect to the curved surface 238 positioned forward of the portions 224 so that the side walls 272 of the legs 275 may overlap the recessed portions of the portions 224 and maintain a smooth transition with the curved surface of the fuel tank 116 positioned adjacent to the side walls 272 of the legs 275 when the rear panel 234 is secured to the fuel tank 116. The side walls 272 and the upper walls 270 of the legs 275 also cover the fasteners 262 and fastener channels 266 positioned along the base of the portions 224 that are used to secure the rearward end of the fuel tank to the lower wall 274 of the legs 275.

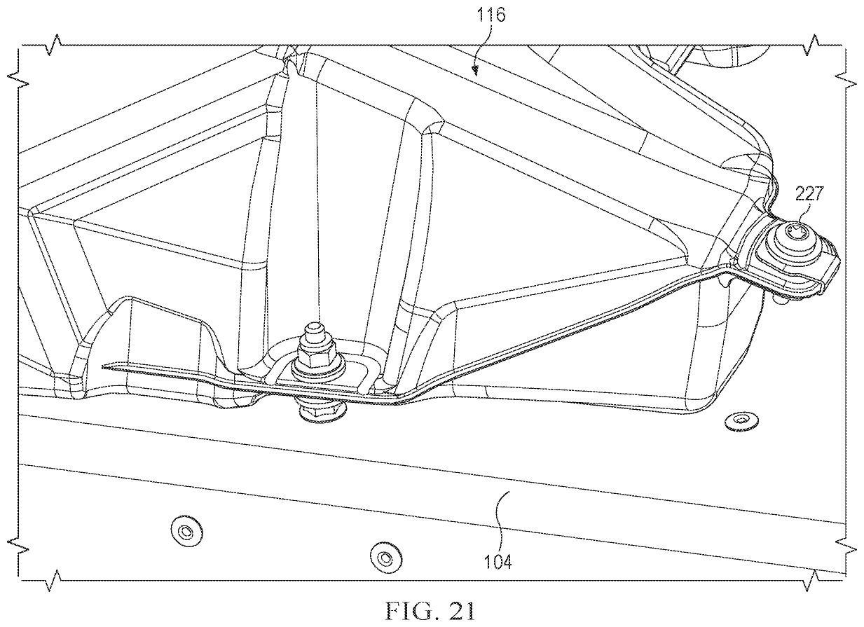

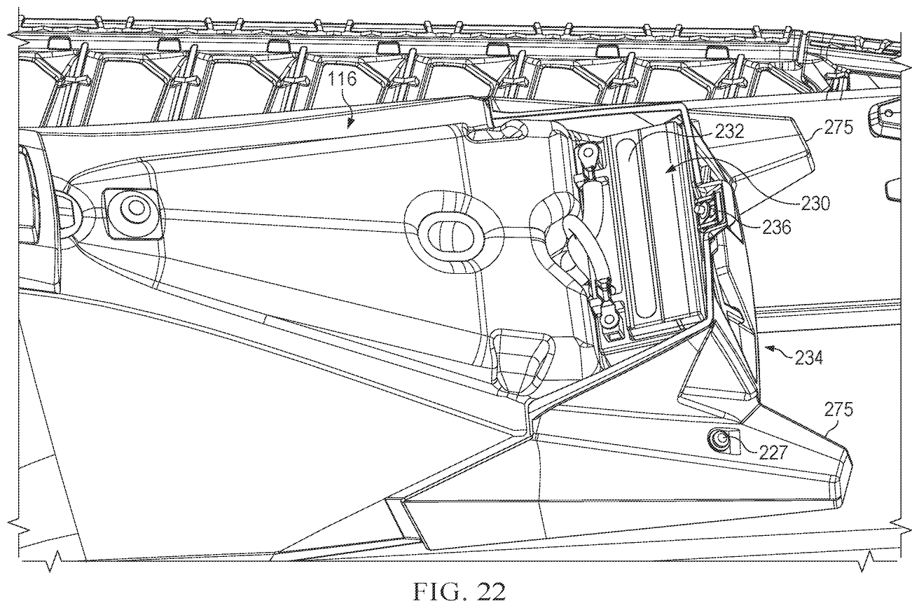

In some embodiments, the rear panel 234 may be configured to provide a forward force to the starter battery 232, and thus, the starter battery 232 is pressed between the rear panel 234 and the fuel tank 116 to firmly secure the starter battery 232 in place. Such configuration may be beneficial, as it may reduce forward/rearward movement and lateral movement of the starter battery 232 within the chamber 230, minimizing wear on the wires and battery terminals. The fasteners 226 may slidably engage with the fastener channels 266 and the tunnel engagement features 264 may slidably engage with the tunnel 104. The fasteners 226 and the tunnel engagement features 264 may limit travel of the rear panel 234. Fasteners 227 may be inserted through the rear panel 234 and the fuel tank 116 (see FIGS. 21-22) to secure the fuel tank 116 to the rear panel 234 and to further limit travel of the rear panel 234. In some embodiments, the fasteners 227 may be configured to provide a press force on the started battery 232, i.e., tightening of the fasteners 227 may press the rear panel 234 into the started battery 232, and hence, press the starter battery 232 into the fuel tank 116.

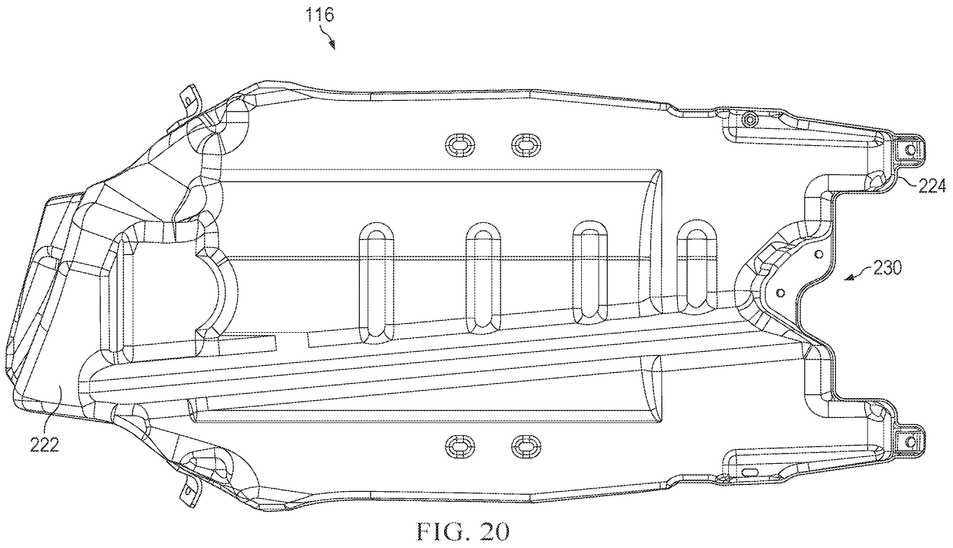

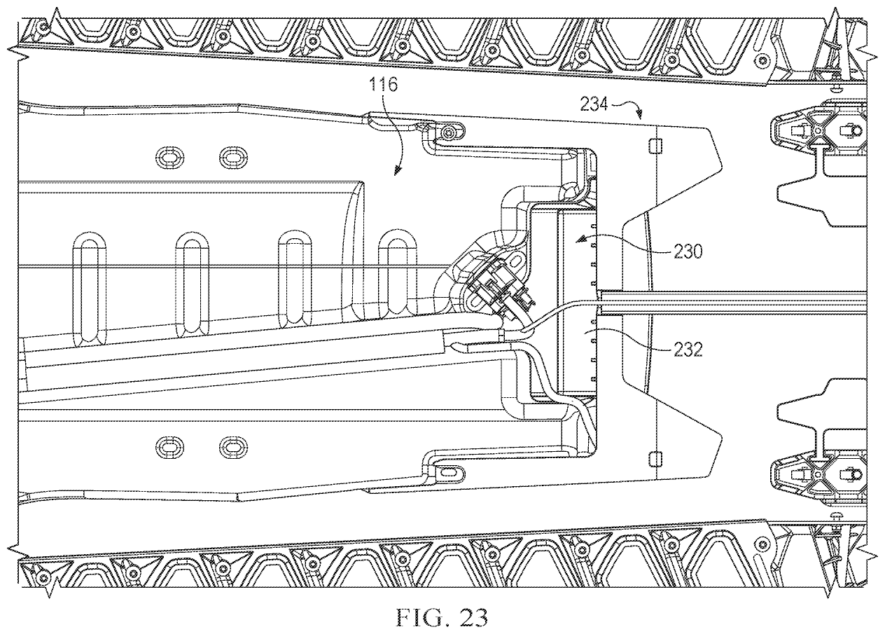

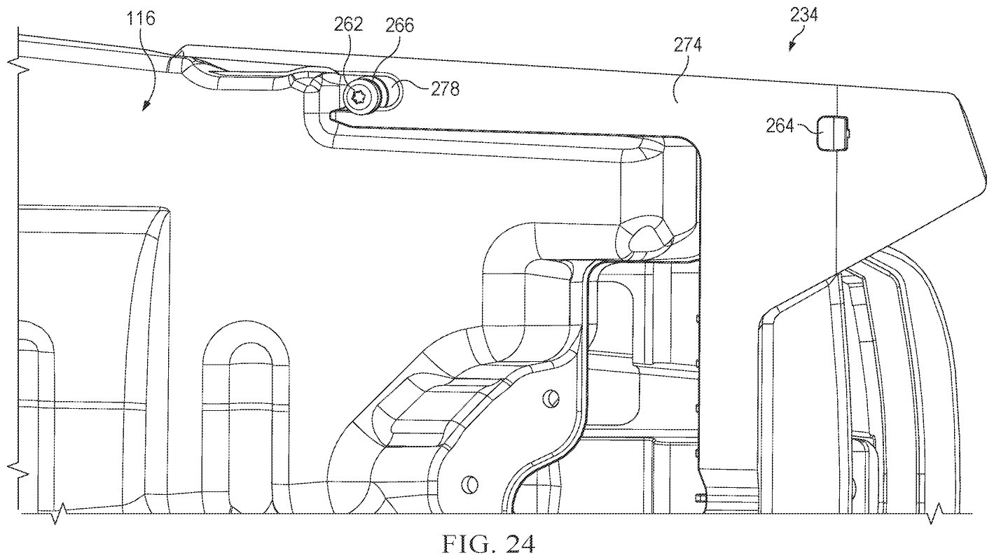

As shown in FIGS. 20 and 21, the lower surface of the portions 224 is upwardly recessed to receive the lower wall 274 of the legs 275 thereunder as shown in FIGS. 23 and 24. The lower walls 274 define a fuel engagement feature 278 at the forward end thereof that receive the fastener 262 to secure the fuel tank 116 thereto. A rearward portion of the legs 275 include one or more tunnel engagement features 264 that may include a hook or foot that is insertable into an aperture in the upper surface of the tunnel so that as the rear panel 234 is slide forward to receive the portions 224 in the chamber 276 defined by the leg 275, the upper surface of the foot extends under the tunnel 104 and engages the underside of the tunnel 104 if an upward force is applied to the rear panel 224. The rear panel 234 may include upper wall apertures 282 to allow a fastener (not shown) to secure the rear panel 234 to the tunnel 104 and/or allow an accessory (not shown) to secure to the rear panel 234.

A shelf 280 is provided that extends along the rear wall 260 between the legs 275 and is shaped to support the battery thereon. The surface of the shelf 280 extends upward as it extends toward the rear wall 260, so that the top surface of the battery is inclined to face in the forward direction as shown in FIG. 22. The rearward facing wall of the fuel tank 116 includes a recess or channel as shown in FIG. 19 that receives the wiring harness extending to the battery and routes the harness to the underside of the fuel tank where a forwardly extending channel 223 as shown in FIG. 20 receives the harness.

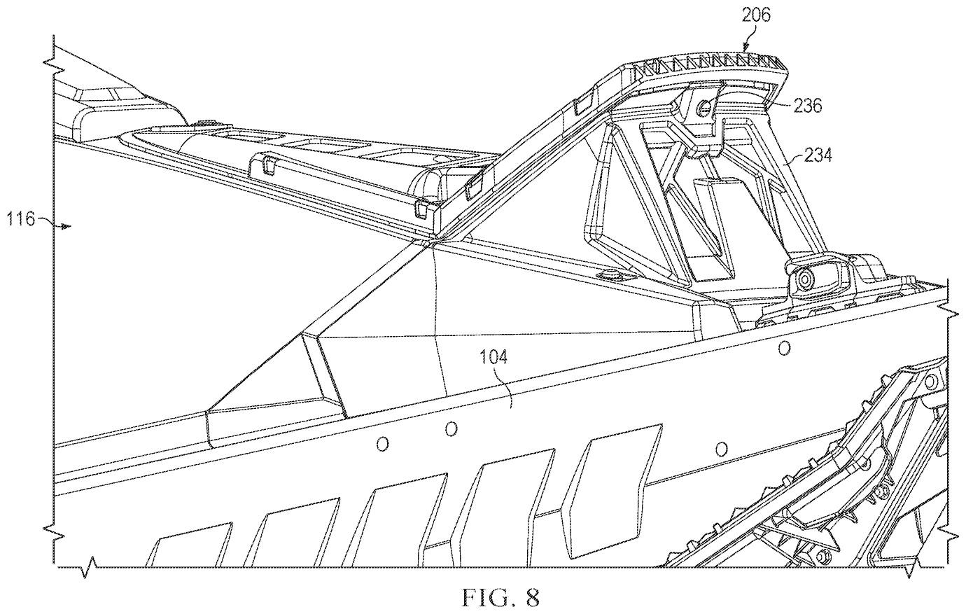

The rear panel 234 may include a latching member 236 shown in FIGS. 8, 9, 26, and 27, for example a quarter-turn fastener, joined with the seat frame 206 to maintain the projections 202 and keyhole slot on the seat frame 206 in engagement with the pockets 208, pillar 212, and disc 214 on the fuel tank 116. This latching member 236 extends to a rearward portion 225 of the seat frame 206 and is further configured to inhibit the seat frame 206 from sliding forward, thus maintaining the location of the pillar 212 in the slot portion 220 of the keyhole-shaped opening 216 until the latching member 236 is disengaged from the seat frame 206. In some embodiments, the latching member 236 may be toolless, i.e., no tool or instrument is required to latch and unlatch the latching member 236. Such toolless latching member would enable the rider to remove and secure the seat frame 206 from the fuel tank 116 and the rear panel 234 with their bare hands. Toolless removal and attachment is desirable, as it allows the rider to access the rear facing chamber anywhere and anytime (e.g., on a riding trail without tools nearby).

The sides of the fuel tank 116 have opposed concave curved surfaces 238 shown in FIG. 16 that are configured to accommodate lower leg portions of a driver standing over the seat 118 when the driver's feet are positioned on the running boards 120. The curved surfaces 238 are configured to allow the driver to stand with each foot on opposite running boards 120 with the legs extending straight from the driver's torso without the lower portion of the driver's legs contacting the curved surfaces 238 of the fuel tank 116. This driving position may be helpful when riding the snowmobile in hilly or mountainous terrain.

The curved surfaces 238 are shaped so that each of the curved surfaces 238 is an unbroken and continuous curve from a base 240 to an upper surface 242 of the fuel tank 116 and from a forward portion 222 to the rearward portion 224 of the fuel tank 116. As shown in FIG. 16, a first width 244 between the of the fuel tank 116 at the base 240 of the forward portion 222 is greater than a second width 246 between the curved surfaces 238 at the base 240 of the rearward portion 224. A third width 248 between the curved surfaces 238 at the upper surface 242 of the forward portion 222 is less than a fourth width 250 between the curved surfaces 238 at the upper surface 242 of the rearward portion 224. The third width 248 between the curved surfaces 238 at the upper surface 242 of the forward portion 222 is at least partially located longitudinally forward of the seat 118. A first minimum distance 252 between the curved surfaces 238 at the upper surface 242 is at least partially disposed longitudinally forward of the seat 118. The first minimum distance 252 between the curved surfaces 238 at the upper surface 242 is disposed longitudinally forward of a location on the seat 118 where the drive sits to rest on the seat. A second minimum distance 254 between the curved surfaces 238 at the base 240 is also disposed longitudinally forward of the location on the seat 118 where the driver's buttocks are configured to rest on the seat. The second minimum distance 254 between the curved surfaces 238 at the base 240 is disposed longitudinally forward of the first minimum distance 252 between the curved surfaces 238 at the upper surface 242.

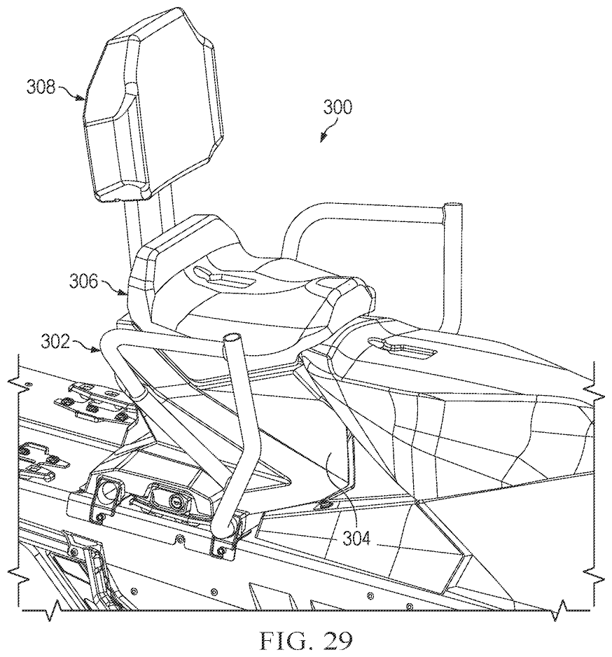

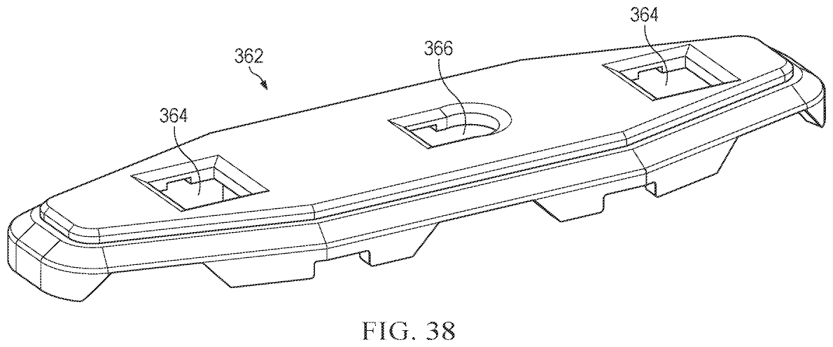

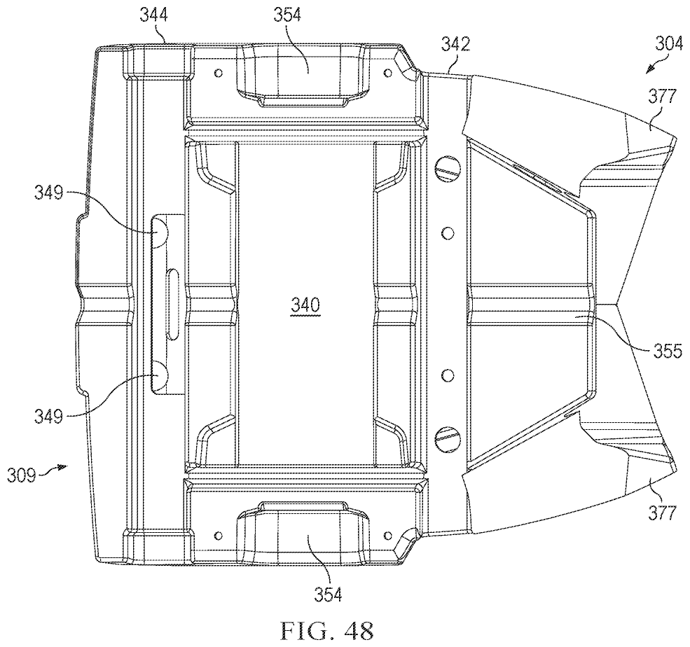

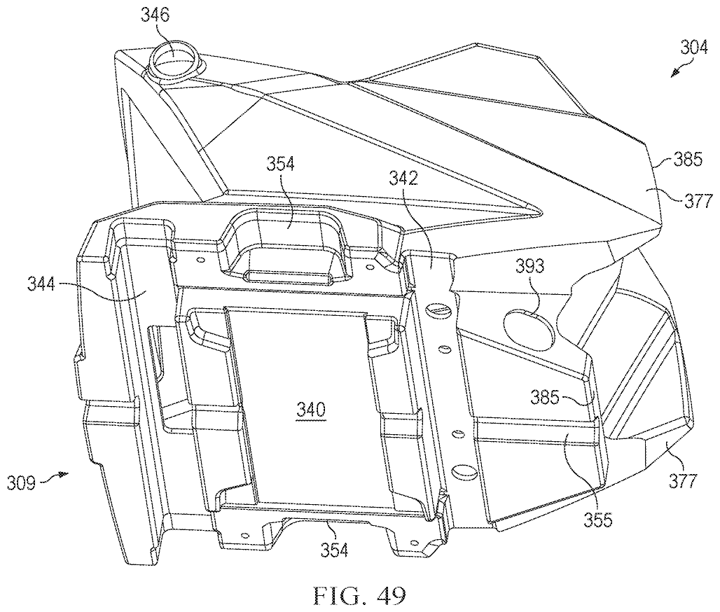

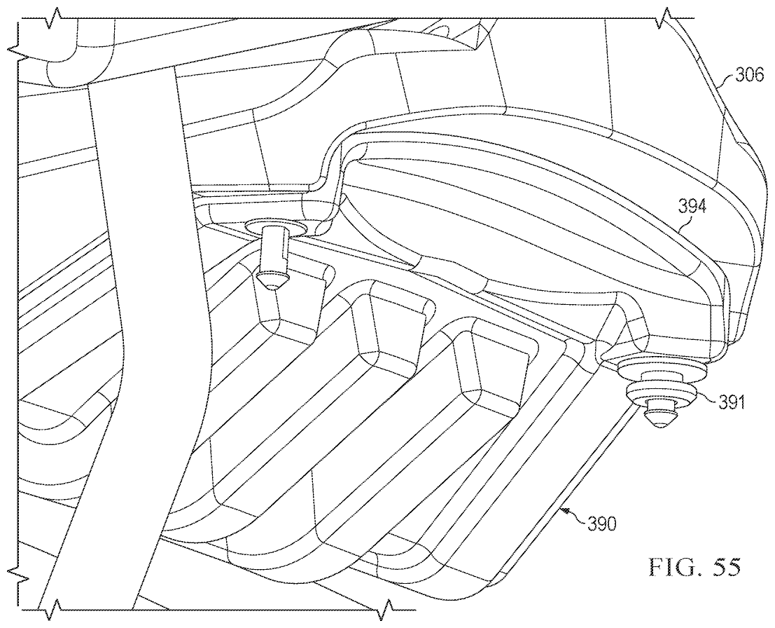

In an embodiment as shown in FIGS. 29-57, a removable seat assembly 300 is provided. The seat assembly 300 may be positioned behind the seat 118 to provide support for an additional passenger. The seat assembly 300 includes one or more of a seat frame 302, a seat riser 304, and a seat cushion 306. The seat assembly 300 is provided with one or more mounting features that are removably engageable with one or more mounting features provided on the tunnel 104 to removably secure the seat assembly 300 thereto. In other words, the seat assembly 300 is removable from the tunnel 104 of the snowmobile 100.

In an illustrative example, the seat assembly 300 includes a first mounting feature that is engageable with a mounting feature positioned on or in a side panel 105 of the tunnel 104, and/or a second mounting feature that is engageable with a mounting feature positioned on or in a top panel 103 of the tunnel 104. Although not limited to such a configuration, the first mounting feature may be configured to locate and align the seat assembly 300 on the tunnel 104 so that the second mounting feature may latch onto the mounting feature positioned on or in the top panel 103 of the tunnel 104 to removably secure the seat assembly 300 thereto.

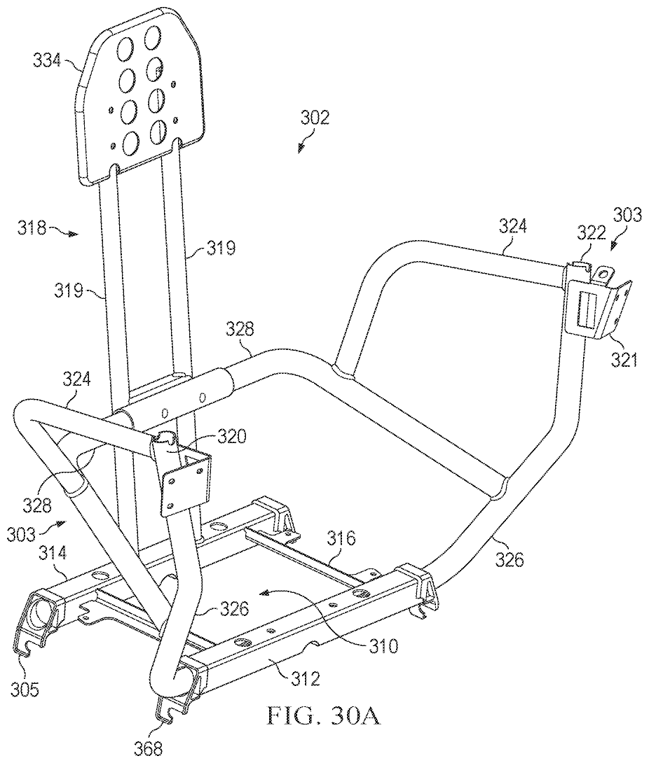

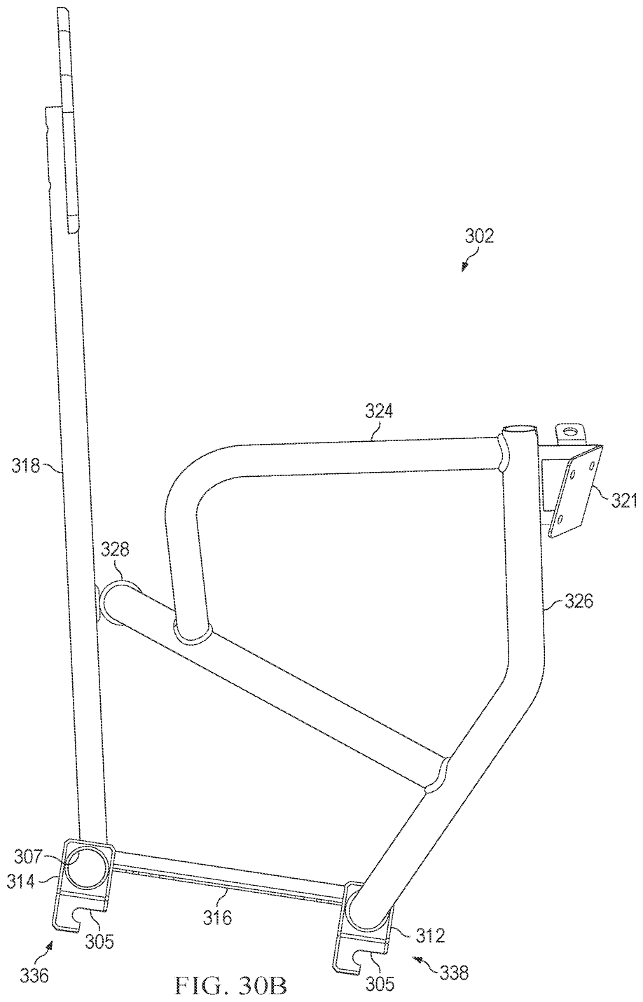

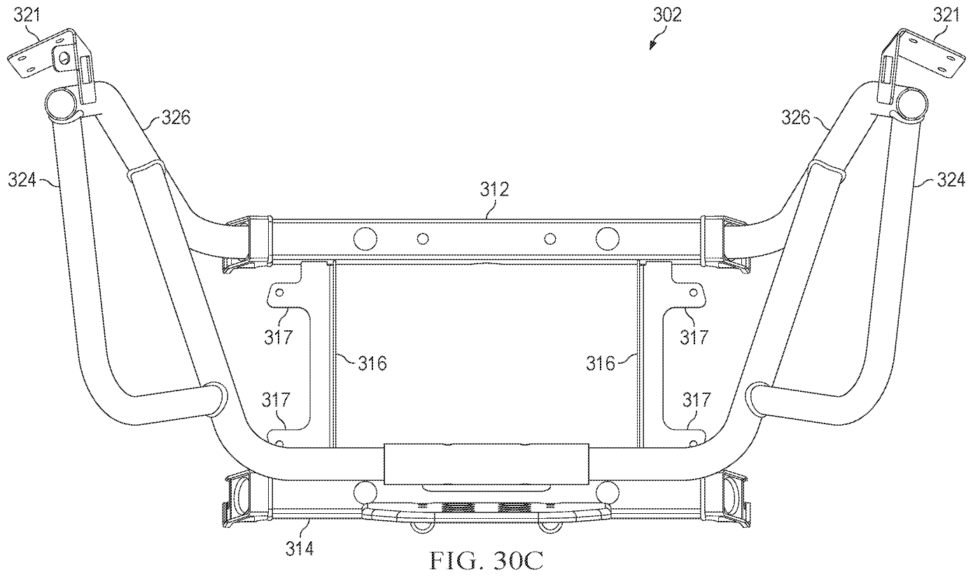

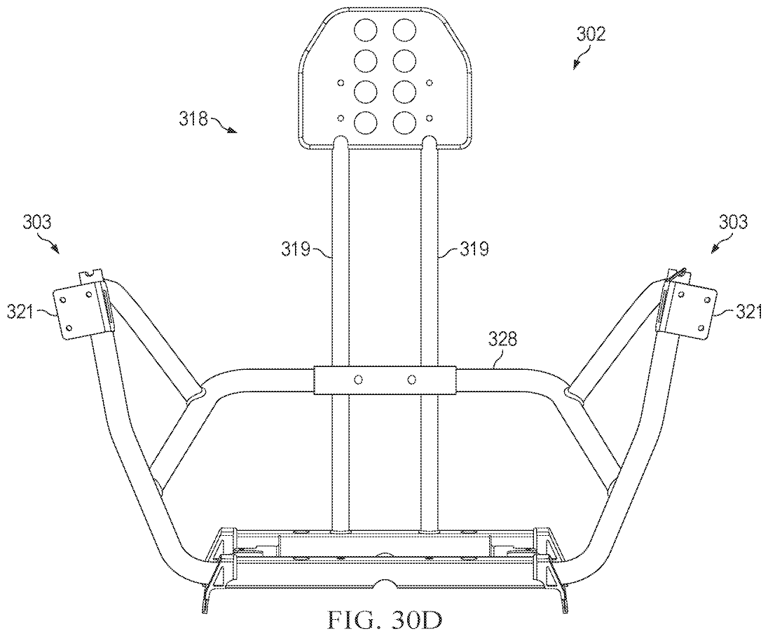

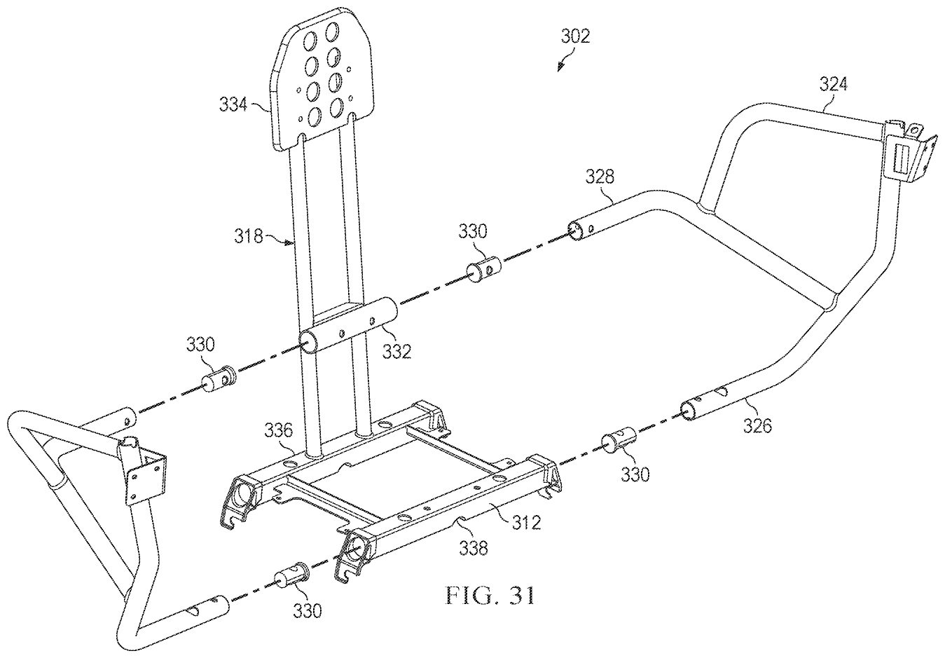

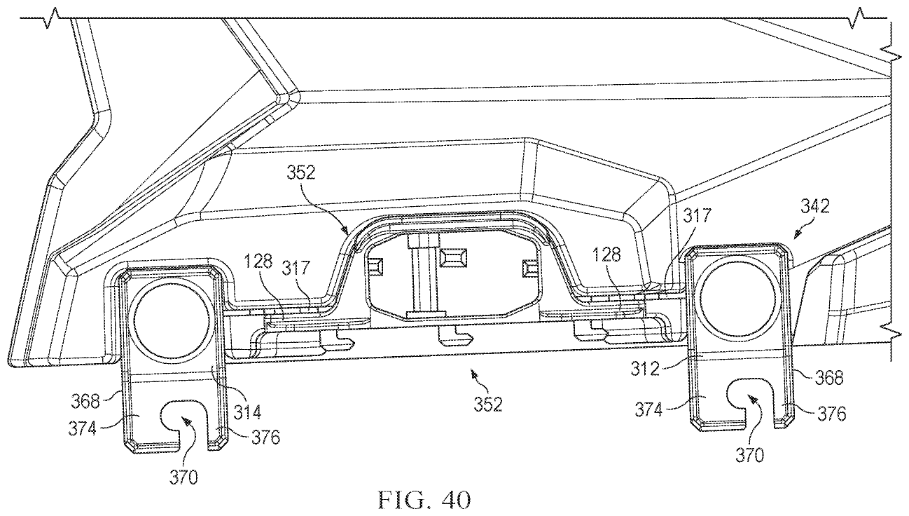

As shown in FIGS. 30A-30D and 31, the seat frame 302 includes one or more arm rests 303 and a frame base 310 comprising a first member 312 and a second member 314 that are positionable on a top panel 103 of the tunnel 104. The first member 312 and the second member 314 may also be referred to as “front member” and “rear member”, respectively. One or more end caps 305 may be provided on outboard ends of the first member 312 and the second member 314. The end caps 305 may include the first mounting feature, such as a flange 368, for removably securing the seat assembly 300 to the tunnel 104. In addition to, or alternatively, the end caps 305 may be provided with a connection sleeve 330 (see FIG. 31) for receiving another portion of the frame 302, such as arm rests 303. In a non-limiting example, at least a portion of the end cap 305 such as a sleeve defining an aperture 307, is formed by casting and may comprise a metal or metal alloy such as steel, aluminum and aluminum alloys. The first member 312 and the second member 314 may be secured together by one or more base brackets 316. The base brackets 316 may be positioned inboard of the end caps 305 and provided with one or more mounting flanges 317 for securing a second mounting feature, such as an attachment member 352, thereto (see e.g., FIG. 40). Positioning of the attachment member 352 inboard of the side panels 105 of the tunnel 104 allows the attachment member 352 to be partially housed in the seat riser 304, thereby shielding the attachment member 352.

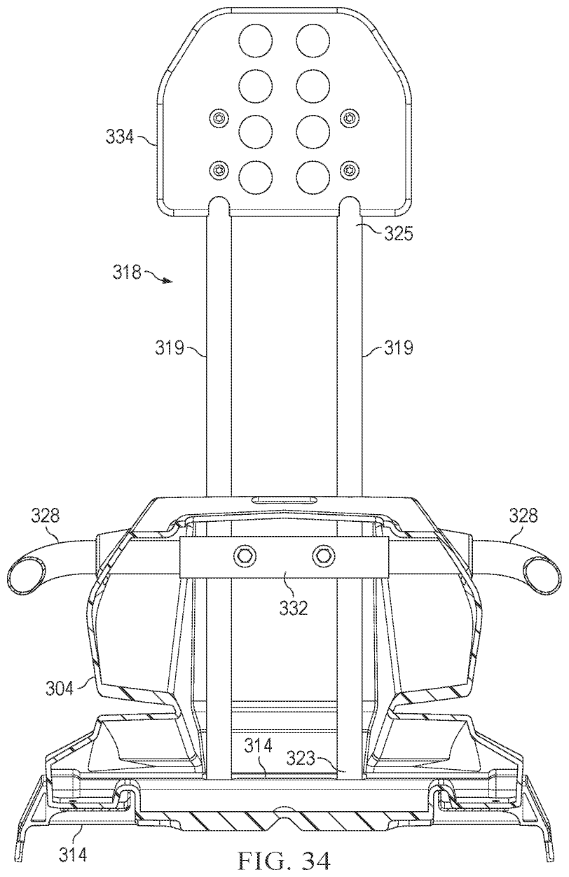

The seat frame 302 may include a seat back frame 318 with one or more features that facilitates assembly of the seat frame 302 with the seat riser 304 and/or allows for the arm rests 303 to function as a structural member of the seat frame 302. In the exemplary embodiment shown in FIG. 34, the seat back frame 318 includes one or more vertical members 319 including a first end 323 that is secured to the second member 314, and a second end 325 that extends upward to a back rest 334 that is removably secured thereto. A rear sleeve 332 may be removably secured to the front of the vertical members 319 for receiving a portion of the arm rests 303 therein. The ability to removably secure the back rest 334 and the rear sleeve 332 to the seat back frame 318 allows for the vertical members 319 of the seat back frame 318 to be inserted through the seat riser 304 before the back rest 334 and the rear sleeve 332 are secured thereto. The ability to secure the arm rest 303 to the seat back frame 318 via, for example, the rear sleeve 332 as well as the frame base 310 via, for example, the end cap aperture 307 provides another connection point for the seat back frame 318 to the frame base 310, thereby allowing the arm rest 303 to function as a structural member of the seat frame 302.

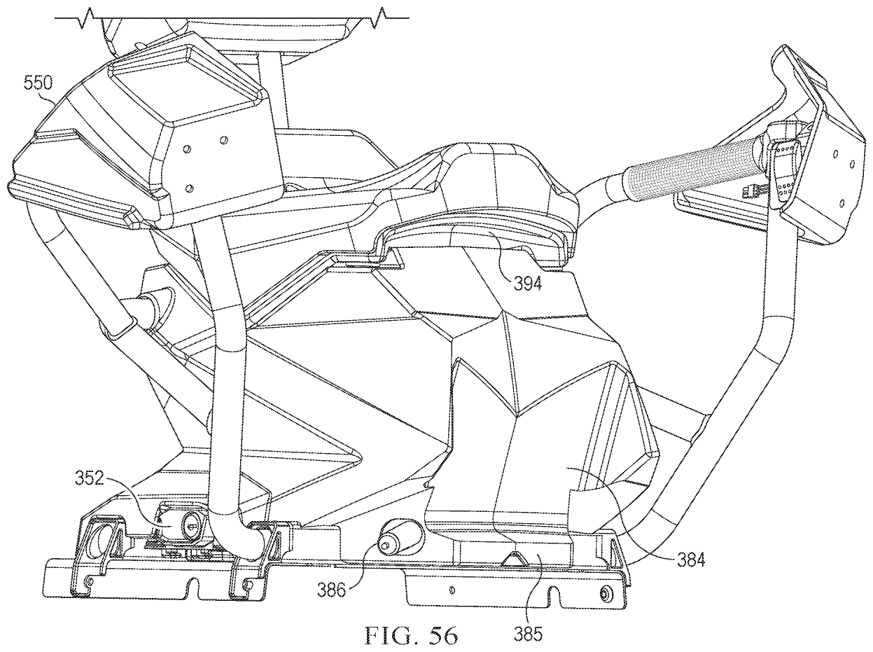

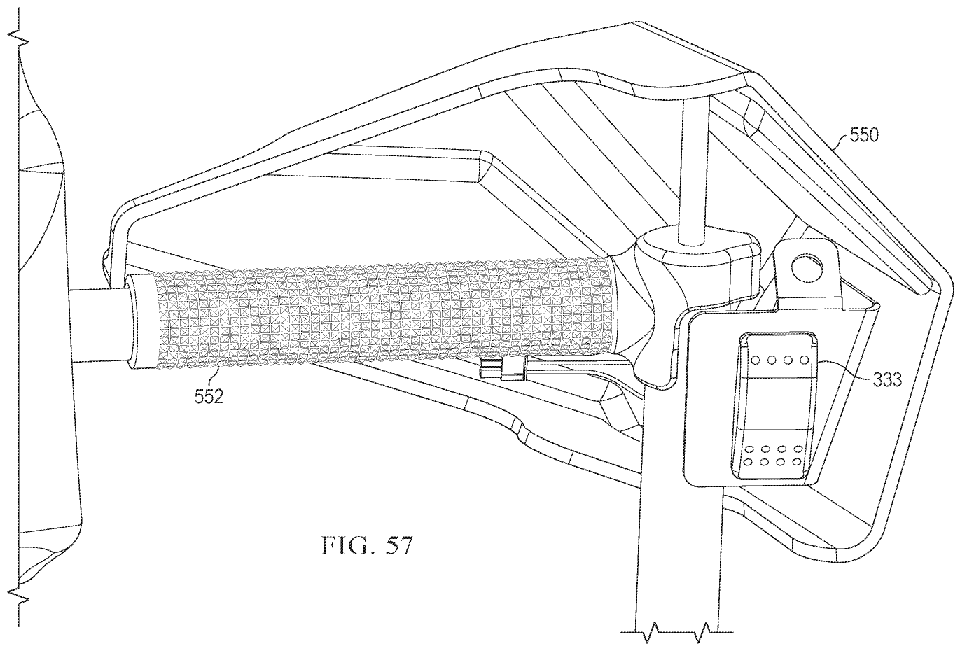

The arm rest 303 may be provided with a first hand grip 320, and a second hand grip 322. Both the first hand grip 320 and the second hand grip 322 include a grip portion 324 configured to allow a second passenger to grasp, a frontal support structure 326, and a rear support structure 328. The hand grips 320 and 322 may be connected at one end to the frontal support structure 326 of the arm rest 303. The frontal support structure 326 may extend substantially downward, rearward and inboard from an upper end secured to the hand grip 320, 322, to a lower end that is received within the aperture 307 of the front end cap 305. The hand grips 320 and 322 may be connected at another end to the rear support structure 328. The rear support structure 328 may include a first end secured to the frontal support structure 326 and may extend upward, inboard and rearward therefrom to a second end secured to the seat back frame 318. In some embodiments, the second end of the rear support structure 328 may be received in the rear sleeve 332 to removably secure the rear support structure 328 to the seat back frame 318. In some embodiments, each of the arm rests 303 may include a bracket 321. The wind guard bracket 321 may be configured to shield a rider's hand from wind, or secure an additional component, e.g., a hand shield 550 (as shown in FIGS. 56-57) to shield a rider's hand from wind. In some embodiments, the hand grips 320, 322 may include a hand heating element 552 (see FIG. 57).

The first arm rest 303 and the second arm rest 303 provide structural support to the removable seat and transfer load from a second end 336 of the frame base 310 to a first end 338 of the frame base 310. In an illustrative example, the rear support structure 328 is secured to the seat back frame 318 and transfers load to the frontal support structure 326. This load transfer helps distribute the load (the second rider weight) between the first end 338 and the second end 336 of the frame base 310. A uniform distribution of load may reduce stress on the tunnel 104 of the snowmobile. For instance, if load was concentrated in the second end 336 of the frame base 310, the portion of the tunnel 104 directly beneath the second end 336 would be under increased stress and the tunnel 104 would require a greater thickness or additional reinforcement in that region. In an illustrative example, the uniform distribution of load allows the tunnel 104 to be comprised of fewer reinforcements and/or a thinner material to reduce the overall weight of the tunnel 104.

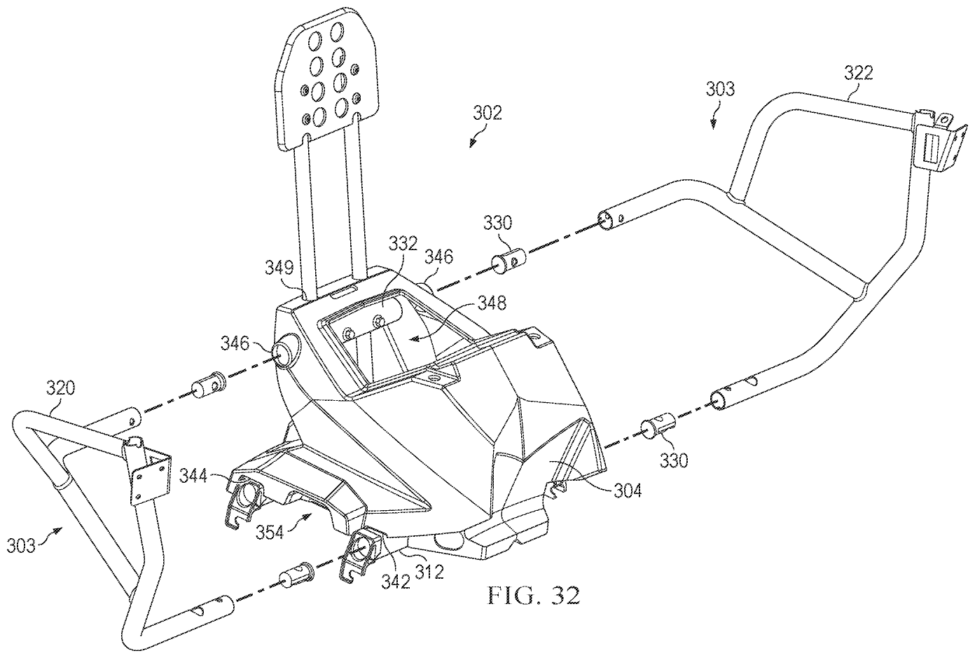

As shown in FIGS. 32-34, the seat riser 304 may be provided with one or more features to facilitate assembly, to position the seat cushion 306 at a desired height, to define a chamber 388 underneath the seat cushion 306, and/or to provide structural support for the seat cushion 306. The riser may be comprised of any suitable material including, but not limited to polymeric materials, fiber or particle reinforced polymeric materials, metals and metal alloys.

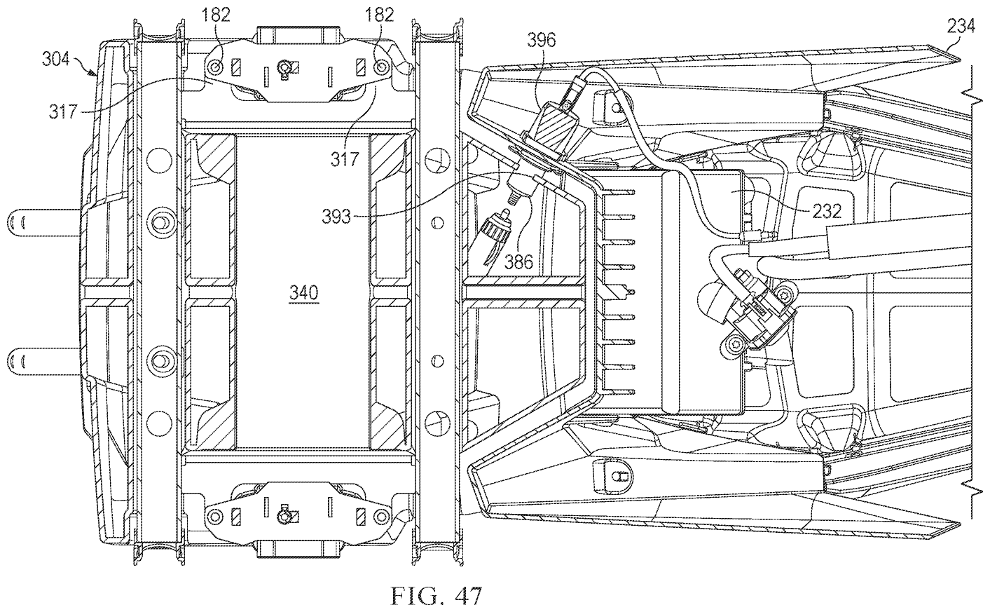

In an embodiment shown in FIGS. 47-49, the seat riser 304 includes a bottom panel 309 with an exterior surface 340 that is positioned opposite the top panel 103 of the tunnel 104, and sidewalls extending upward therefrom to define the chamber 388 that is accessible via an opening 348 defined in the top of the seat riser 304. The bottom panel 309 includes a front channel 342 to receive the first member 312 and a rear channel 344 to receive the second member 314. One or more removable fasteners may be inserted via the chamber 388 through apertures provided on the bottom surface of the seat riser 304 and into the first member 312 and the second member 314 to secure the seat riser 304 to the frame base 310. As shown in FIGS. 40-42, the front channel 342 and the rear channel 344 may be substantially U-shaped, and regions of the bottom panel 309 to the front and the rear of the front channel 342 and the rear channel 344 may optionally be positioned to abut the top panel 103 of the tunnel 104 to increase the surface area of the seat assembly in contact with the tunnel 104. One or more recesses 354 may be provided in the bottom panel 309 and the side walls between the front channel 342 and the rear channel 344 to receive the attachment member 352 therein. Housing the attachment member 352 within the recess 354 of the seat riser 304 protects the attachment member 352 during operation of the vehicle. One or more channels 355 may be provided that extend from the front of the bottom panel 309 to the rear of the bottom panel 309 to accommodate an electrical harness extending from the battery 232 to the taillight positioned at the rear of the tunnel 104. The first member 312 and the second member 314 may also include recesses to accommodate for the passage of the electrical harness between the first member 312, the second member 314 and the top panel 103 of the tunnel 104.

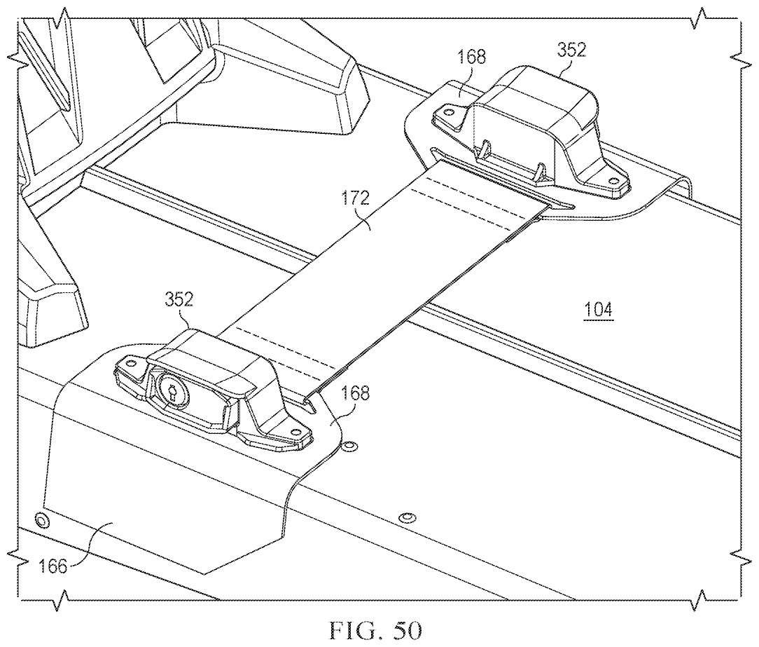

The exterior surface 340 of the bottom panel 309 may also be shaped to accommodate one or more accessory attachments positioned on or along the top panel 103. In some embodiment, such as the embodiment illustrated in FIG. 50, two of the attachment members 352 may be secured to the tunnel and connected via a flexible strap 172. A bracket and a mounting plate 166 may be secured to each of the attachment members 352. In some embodiments, the mounting plate 166 may be configured to secure a saddle bag, or other accessory, to the tunnel 104. Thus, the exterior surface 340 may be shaped to create clearance for the flexible strap 172, the mounting plate 166, and/or the bracket 168.

At least a portion of one or both of the seat back frame 318 and the arm rests 303 are housed in the chamber 388 defined by the seat riser 304. In an illustrative example, the removable rear sleeve 332 is positioned in the chamber 388 and the side walls of the seat riser 304 define one or more through-holes 346 to allow the rear support structure 328 to pass therethrough. Accordingly, the ends of the arm rests 303 can be inserted into the removable rear sleeve 332 and removably secured thereto with, for example, threaded fasteners during assembly. Similarly, the upper end of the seat back frame 318 can be inserted into the seat riser 304 through openings in the bottom panel 309 and out of the chamber through openings 349 defined on an upper surface of the seat riser 304 rearward of the opening 348. After which, the back rest 334 may be removably secured to the upper end of the seat back frame 318 with, for example, threaded fasteners. As shown in FIG. 32, the removable rear sleeve 332 can be secured to the seat back frame 318 with, for example, threaded fasteners during assembly inside the chamber 388 via the opening 348 defined in the top of the seat riser 304.

In some embodiments, the seat riser 304 may support a vertical load (e.g., a passenger's weight), and the seat frame 302 may support a non-vertical load (e.g., a passenger shifting laterally, longitudinally, or grabbing/pulling on the arm rests 303). In other embodiments, the seat riser 304 and the seat frame may share both vertical load and non-vertical load.

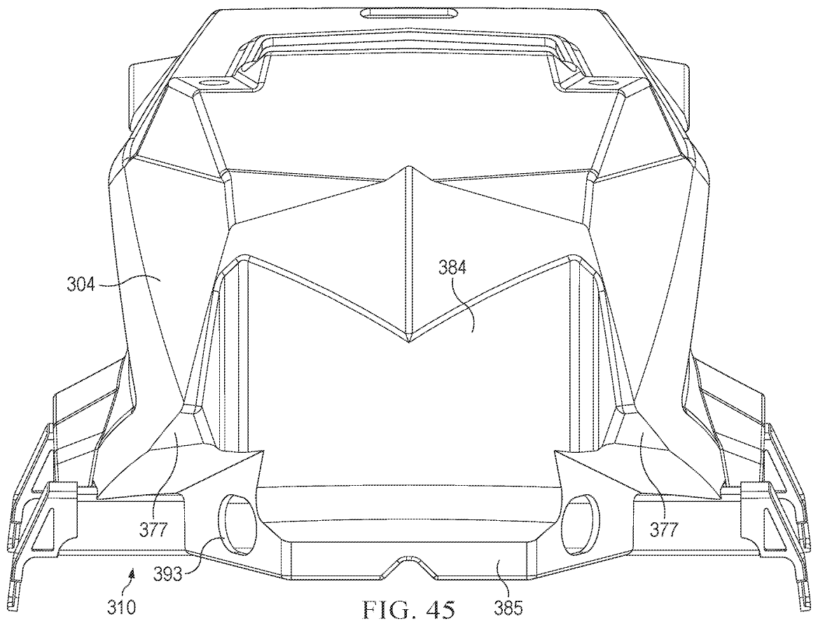

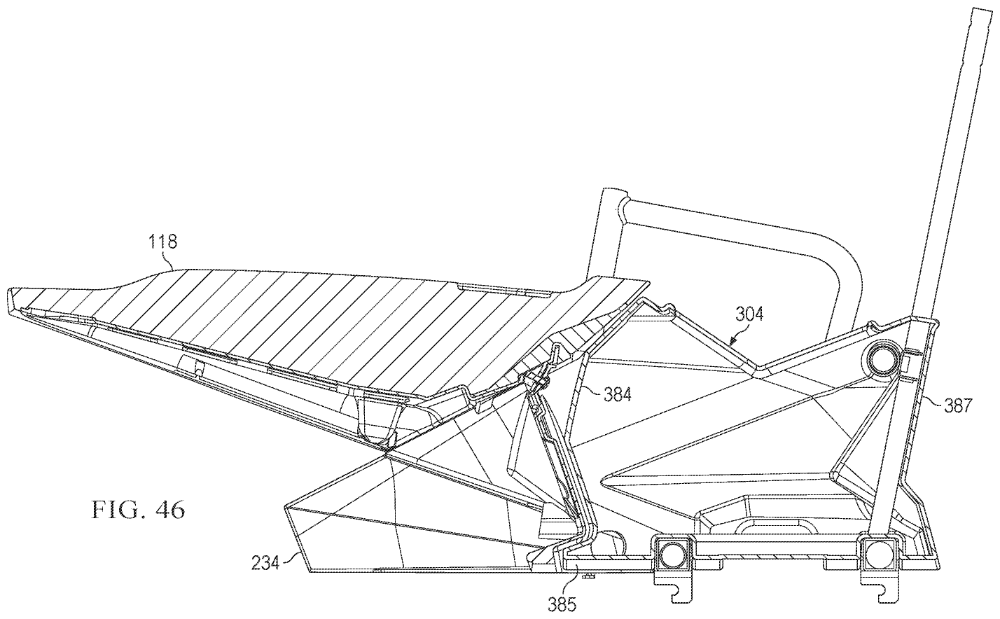

The seat riser 304 may include a front wall 384 shaped to facilitate integration of the seat assembly 300 with one of more components of the seat 118. The front wall 384 extends between outboard portions 377 from the bottom panel 309 to the top of the seat riser 304 forward of the opening 348. The lower portion of the front wall may include a forwardly projecting foot 385 that abuts or is positioned along the top panel 103 of the tunnel 104 and is received between the legs of the rear panel 234 and in a recess defined by the rear panel 234 so that the foot 385 is positioned underneath the battery shelf of the rear panel 234 and a battery if present thereon. The outboard portions 377 of the riser 304 are positionable over the outboard legs 275 of the of the rear panel 234 when the foot 385 is received in the chamber to provide additional support to the forward end of the riser 304. As shown in FIG. 46, a first portion of the front wall 384 that is positioned between the outboard portions 377 extends upwardly and fowardly from the foot 385 along the rear wall of the rear panel 234, and a second portion extends upwardly and rearwardly from the first portion and is optionally positionable to abut a downward and rearward facing surface of the seat cushion of the seat 118. As shown in FIG. 45, the foot 385 does not extend from the outboard portions 377 of the side walls, so that the foot 385 is positioned between the rearward projecting feet 275 of the rear panel 234 with the rearward projecting feet positioned beneath at least a portion of the seat riser 304.

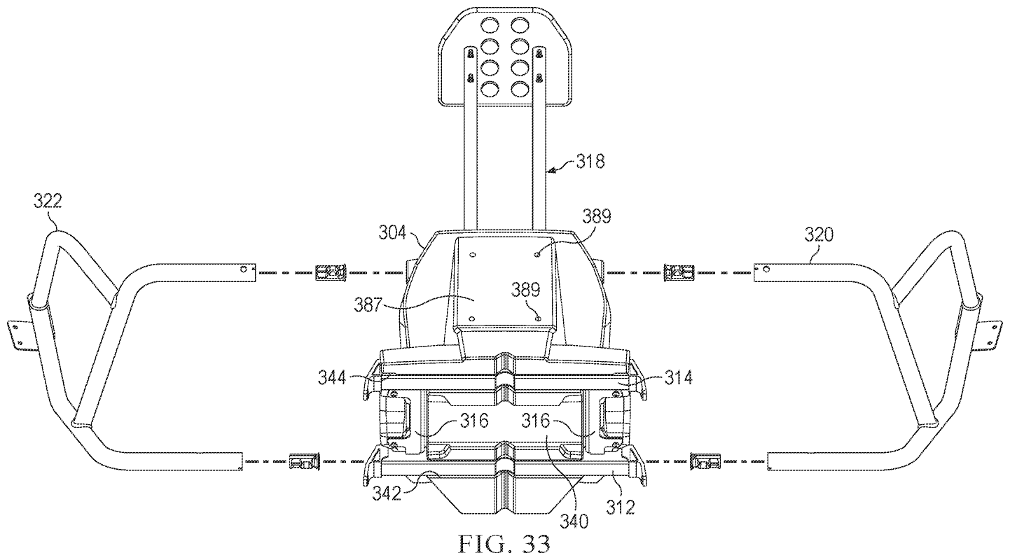

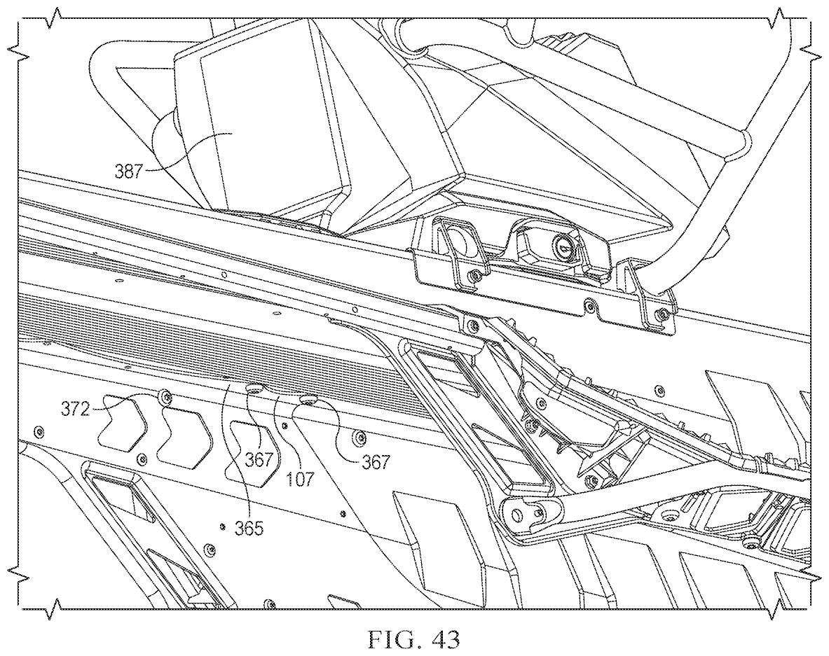

As illustrated in FIGS. 33 and 46, the seat riser may include a rear wall 387 including one or more mounting holes. The one or more mounting holes may be configured to receive, for example, a threaded fastener to removably secure the vertical member 319 of the seat back frame 318 to the seat riser 304. The rear wall 387 and rear mounting holes 389 may redistribute a load from the seat frame 302 to the seat riser 304, or vice-versa. In other embodiments (see e.g., FIG. 43), the rear wall 387 does not include one or more mounting holes.

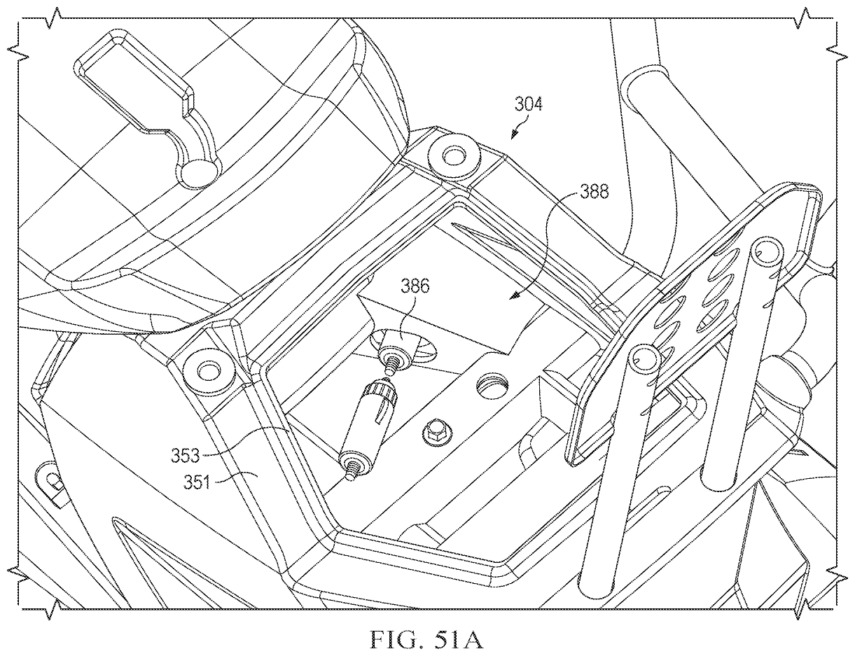

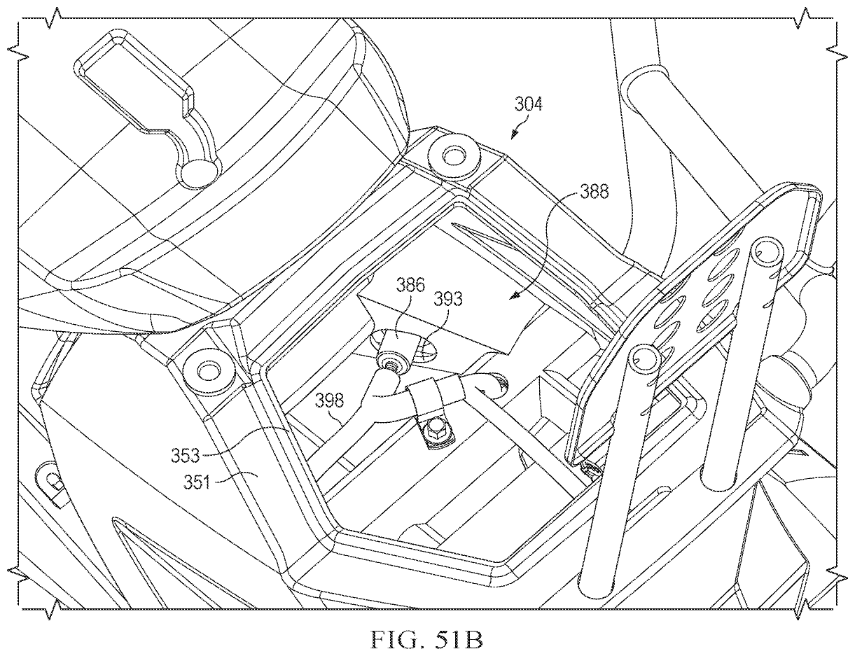

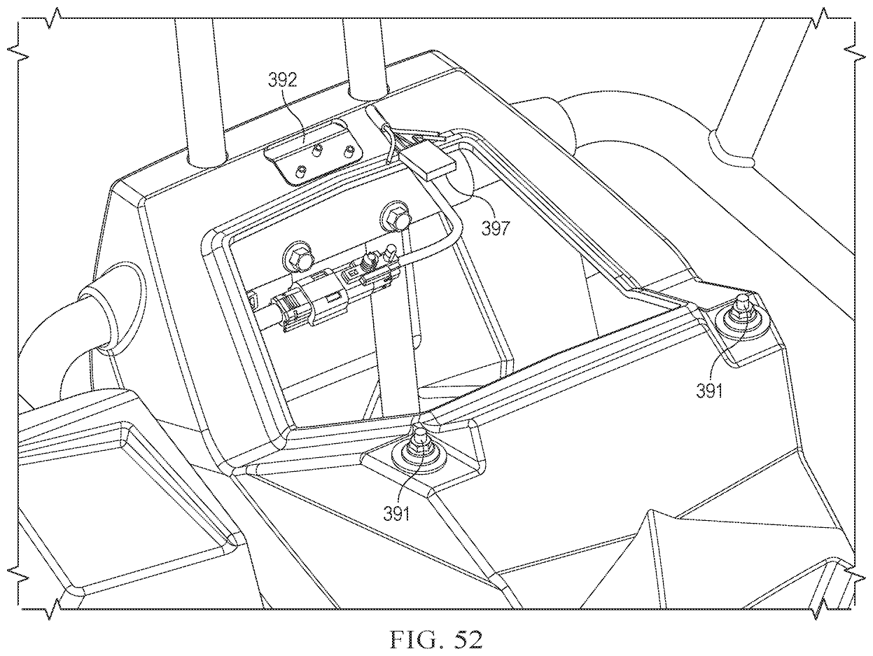

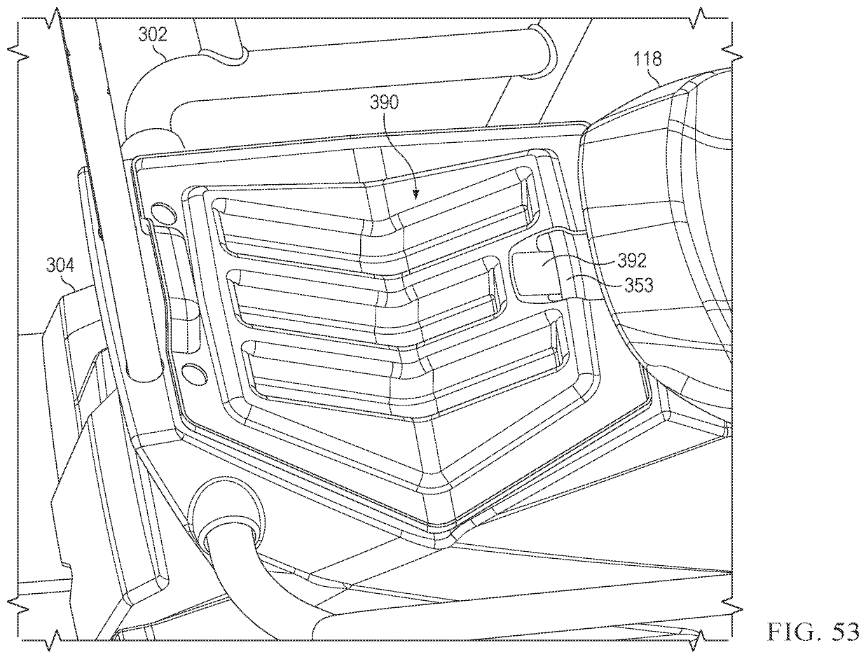

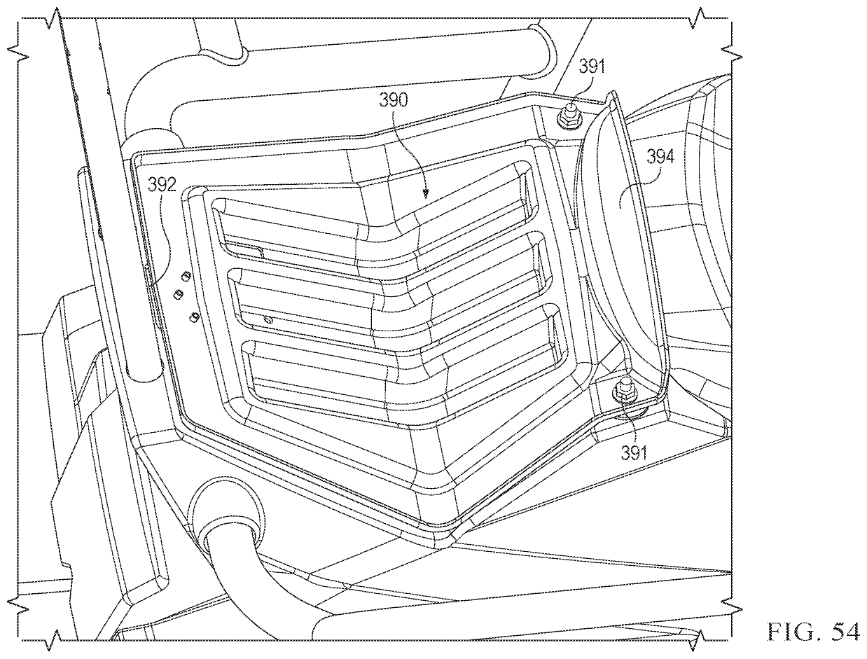

The seat riser 304 and the seat cushion 306 may be provided with one or more features that allow for the toolless removal of the seat cushion 306 from the seat riser 304 to facilitate easy access to the chamber 388. As shown in FIGS. 51A-B, the upper portion of the seat riser 304 includes a flat surface 351 surrounding a lip 353 that at least partially defines the opening 348 to the chamber 388. As shown in FIG. 53, a seat cushion frame 390 that is secured to the underside of the seat cushion 306 may be provided with a flange extending along at least a portion of the perimeter of the seat cushion frame 390 for positioning on the flat surface 351, and a recess defined on an underside of the seat cushion frame 390 inboard of the flange. The recess is shaped to receive the lip 353 therein to align the seat cushion 306 on the seat riser 304. The seat cushion frame 390 may be provided with one or more retaining features for removably securing the seat cushion 306 to the seat riser 304. For example, one side of the seat cushion frame 390 may be discontinuous and provided with a clip 392 that is insertable underneath the lip 353 (see FIG. 52). Although the clip 392 is shown at the forward end of the seat cushion frame 390, it may be positioned on any side of the seat cushion frame 390. In a non-limiting example as shown in FIG. 53, the clip 392 is positioned at the rear of the seat bottom 390 and is positioned underneath the lip 353 at the rear of the opening 348. A portion of the side of the seat cushion frame 390 positioned opposite the clip 392 may be raised to provide a gap between the upper portion of the seat riser 304 and the seat cushion frame 390. This raised portion may operate as a hand grip 394 to lift and pivot the seat cushion 306 to disengage the tongue or clip 392 from the seat riser 304 and allow for removal of the seat cushion 306 from the seat riser 304. Accordingly, the design allows for the toolless removal of the seat cushion 306 from the seat riser 304 to facilitate easy access to the chamber 388. As shown in another nonlimiting example in FIG. 54, the seat cushion frame 390 may include one or more locating pins 391 that are insertable into apertures located in the top of the seat riser 304 on opposite sides of the hand grip 394. The locating pins 391 may be configured to secure the seat cushion frame 390 onto the seat riser 304 and to help position the seat cushion frame 390. In a non-limiting example, at least a portion of one or both of the seat cushion frame 390 and the seat cushion 306 may extend over the rearward end of the seat cushion of the seat 118.

As shown in FIG. 29, nesting of different features between the seat riser 304 and the rear panel 234 provides for a continuous outboard surface extending from the front of the tunnel 104 and the rearward legs of the chassis 102 to the rear of the removable seat 300. In addition to, or alternatively, the arrangement positions the seat cushion 306 in contact with the seat cushion of the seat 118 to provide a substantially continuous seating surface between the two seats. In a non-limiting example, the forward end of the cushion 306 may include a recess that receives the rearward end of the cushion of the seat 118 as shown in FIG. 29.

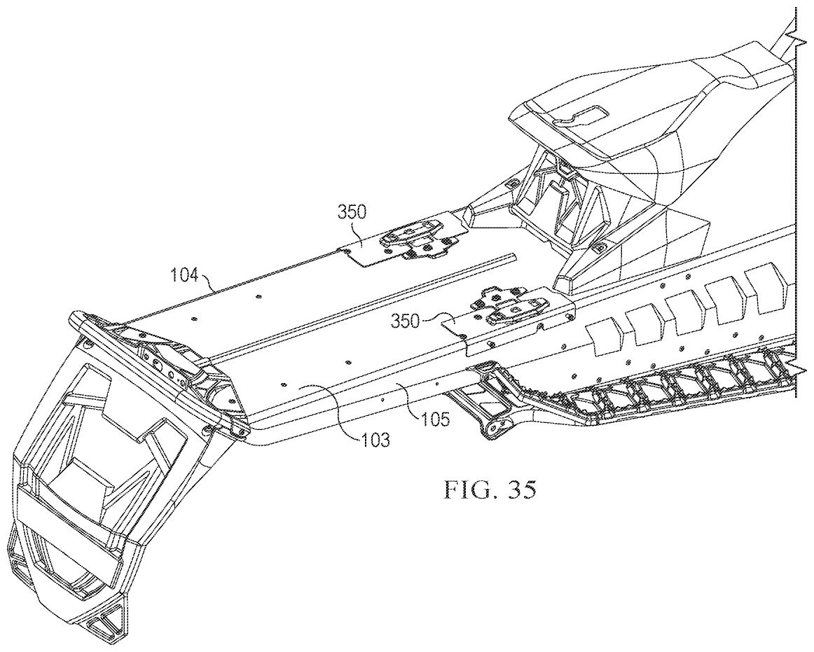

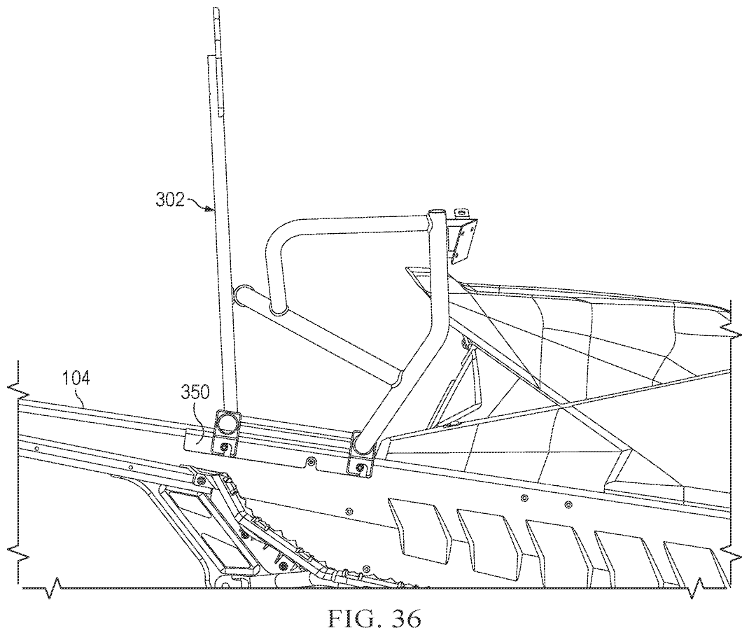

In some embodiments, an external bracket 350 may be added to the tunnel 104 of the snowmobile 100 (see FIGS. 35-36) to provide additional clearance and/or reinforcement. In a non-limiting example, the bracket 350 may be positioned to redistribute load to the edge of the tunnel 104 that is capable of bearing a heavier load than the center of the top panel 103 of the tunnel 104. The bracket 350 may be placed over an interiorly reinforced portion 107 of the tunnel 104 and help redistribute the load to the reinforced portion of the tunnel 104 (see FIG. 43). The bracket 350 may add structural strength to the tunnel 104. In some embodiments, the bracket 350 can be made from steel or other metal alloys with a higher strength and/or thickness than the tunnel 104. The removable seat can be secured on top of and/or on the side of the bracket 350 to distribute the load of the passenger seated thereon.

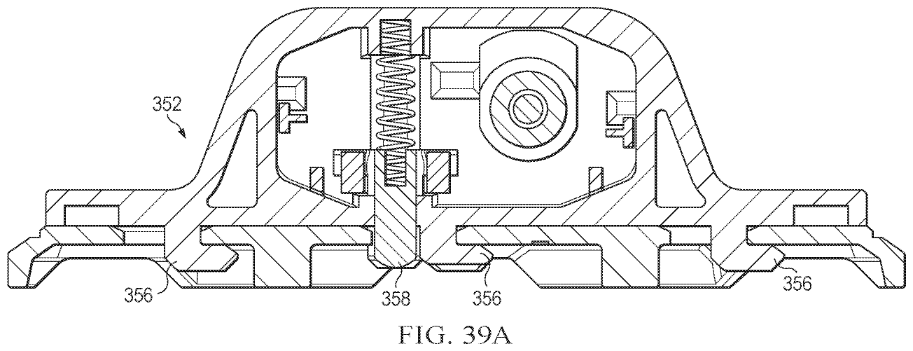

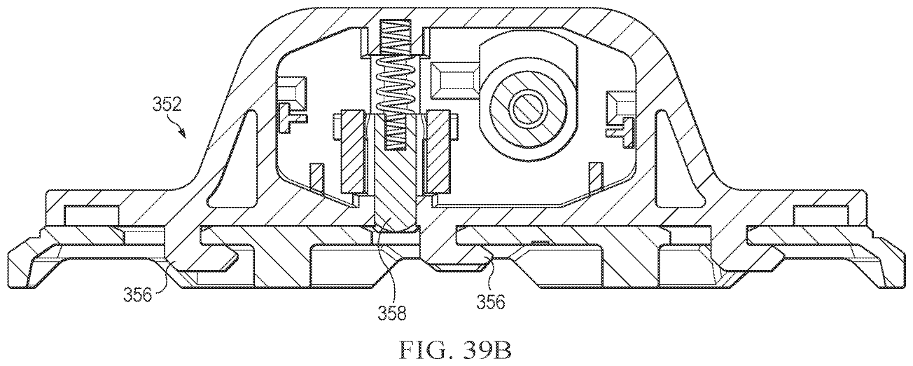

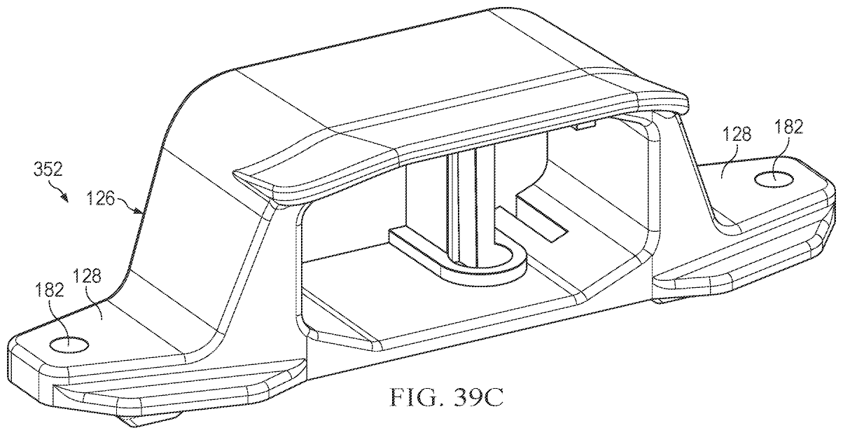

The seat assembly 300 is provided with one or more mounting features that are removably engageable with one or more mounting features provided on the tunnel 104 to removably secure the seat assembly 300 thereto. In some embodiments, the seat 300 may include one or more attachment members 352 that are securable to the top panel 103 of the tunnel 104. The attachment members 352 can be secured to the frame base 310 and allow the rider to attach and remove the seat assembly 300 to/from the snowmobile 100. In some embodiments, the attachment member 352 can be secured to the base bracket 316 and/or the seat riser 304, with the attachment member 352 housed in the recess 354 of the seat riser 304. In a non-limiting example shown in FIG. 39C, the attachment member 352 is provided with a housing 126 including flanges 128 with mounting holes 182. The attachment member 352 is positioned along the outboard side of the base brackets 316 with the mounting holes 182 coaxially aligned with the mounting holes in mounting flanges 317 of the base brackets 316 (see FIGS. 30C and 40). In the non-limiting example shown in FIGS. 40 and 51B, the flanges 128 of the attachment member 352 are positioned beneath the flanges of the base bracket 316, and fasteners are inserted through the mounting holes 182 of the attachment member 352, through the mounting holes of the base brackets 316, and into the exterior surface 340 of the bottom panel 309 of the seat riser 304 to removably secure the attachment member 352 thereto.

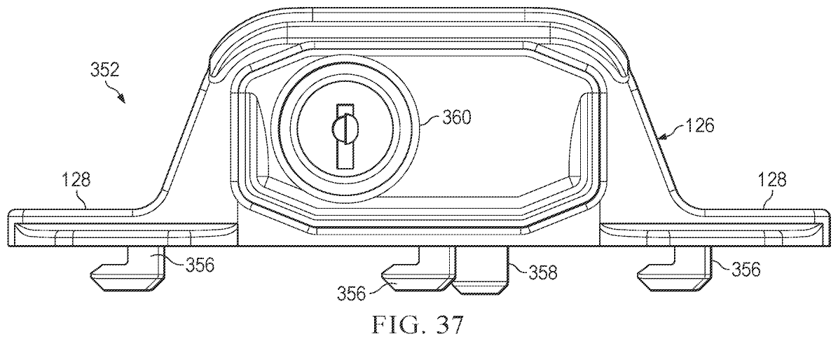

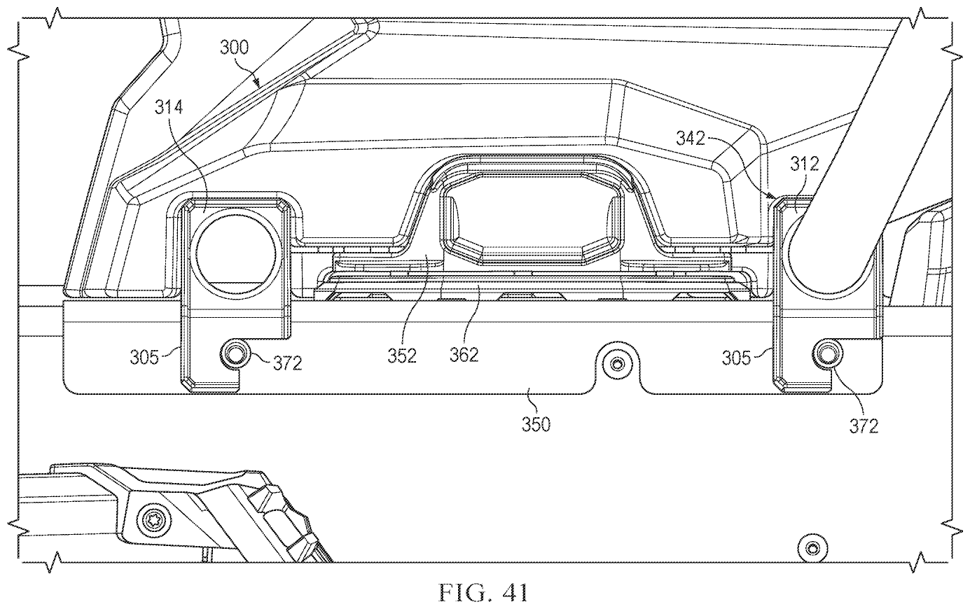

FIGS. 37, 39A-39C, and 50 show an exemplary attachment member 352. The attachment member 352 is further described in U.S. Provisional Patent App. No. 63/310,264 filed Feb. 15, 2022, entitled “Accessory Attachment System,” which is hereby incorporated by reference in its entirety. The attachment member 352 includes one or more stationary features, such as one or more hooks 356, a movable feature, such as a locking pin 358, and a release button 360 that can retract the locking pin 358 inside the housing of the attachment member 352 when depressed. In some embodiments, the locking pin 358 may include a spring-biased plunger. The hooks 356 and the locking pin 358 are configured to be vertically inserted into openings defined by the tunnel 104 and/or an attachment base 362 with one or more hook openings 364 and a pin opening 366. In a non-limiting example, the attachment base 362 is secured to the top panel 103 of the tunnel 104 with one or more fasteners inserted from inside of the tunnel 104 into the bottom of the attachment base 362. Optionally, as shown in FIG. 43, a bracket 365 may be positioned on the interior of the top panel 103 and the interior of the side panel 105 of the tunnel 104 to provide additional support to the seat assembly, and the fasteners 367 may extend through the portion of the bracket 365 positioned along the underside of the top panel 103, the top panel 103 of the tunnel 104, and into the underside of the attachment base 362. Once the hooks 356 are vertically inserted into the hook openings 364, 366, the attachment member 352 may be slid, for example, forward along the length of the tunnel 104 into a locking position (see FIGS. 39A and 41) where the top of the hooks 356 are positioned along an underside of the attachment base 362 to prevent withdrawal of the hooks 356 from the hook openings 364 and 366. When the locking position is reached, the spring-biased locking pin 358 will automatically extend into the pin opening 366 and lock the attachment member 352 to the snowmobile 100 by preventing sliding of the attachment member 352 rearward to align of the hooks 356 with the openings 364 and 366.

For instance, in FIG. 39A, the locking pin 358 is deployed and extends downward. In contrast, FIG. 39B illustrates the locking pin 358 in the unlocked position, with the locking pin 358 retracted within the housing of the attachment member 352. When the locking pin 358 is deployed into the attachment base 362, the locking pin 358 will prevent any forward or backward slide motion while the hooks 356 will prevent the attachment member 352 from lifting vertically off the snowmobile 100.

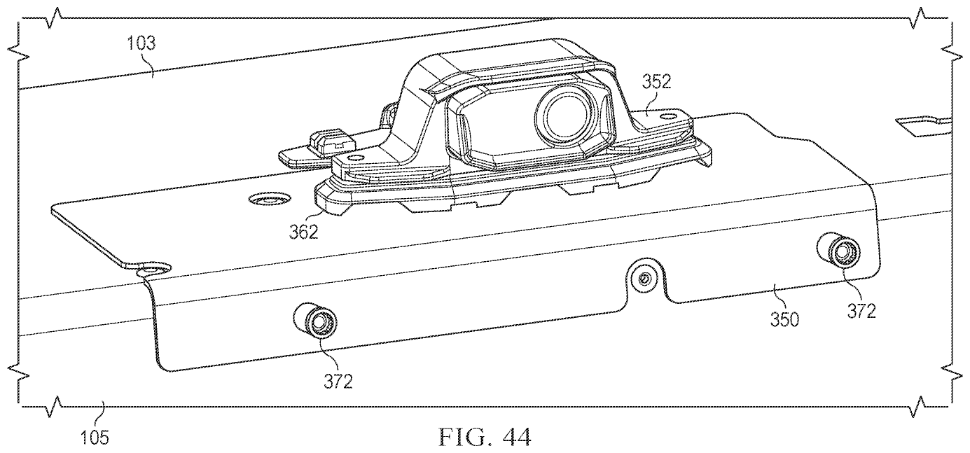

The attachment base 362 may be disposed on the bracket 350, or in other embodiments, the attachment base 362 may be secured directly to the tunnel 104. FIG. 44 shows an exemplary embodiment wherein the attachment base 362 is secured to the top surface of the bracket 350, with the attachment member 352 locked into the attachment base 362. It is to be understood that the attachment member 352 can be directly secured to the tunnel 104 without the use of the attachment base 362. In a non-limiting example, the tunnel 104 may be provided with openings similar to the hook openings 364 and 366 that allow the attachment member 352 to be directly secured to the tunnel 104 without the attachment base 362.

The frame base 310 may include one or more mounting features for removably securing the seat assembly 300 to one or both of the side panels 105 of the tunnel 104. In a non-limiting example, the mounting features may be flanges 368 (see FIGS. 40-43) that extend downward from the end caps 305 and are positioned along the outboard surfaces of the side panels 105. Positioning of the flanges 368 on opposite sides of the tunnel 104 may provide additional stability to the seat assembly 300 as the flanges 368 serve as a stop and inhibit lateral movement of the seat assembly 300 across the width of the tunnel 104. One or both of the flanges 368 may include a channel 370 configured to receive a protrusion 372 extending from an interior of the tunnel 104 and through the side panel 105 of the tunnel 104. One or both of the protrusions 372 may also extend through the internal bracket 365, and through the tunnel 104, and optionally through the bracket 350. In some embodiments, the protrusion 372 may extend from the tunnel 104 and through the reinforcement bracket 350. In some embodiments, the flange 368 may include a front channel stop 376 (see FIG. 40) while in other embodiments, the flange 368 will not include the front channel stop 376 (see FIG. 41).

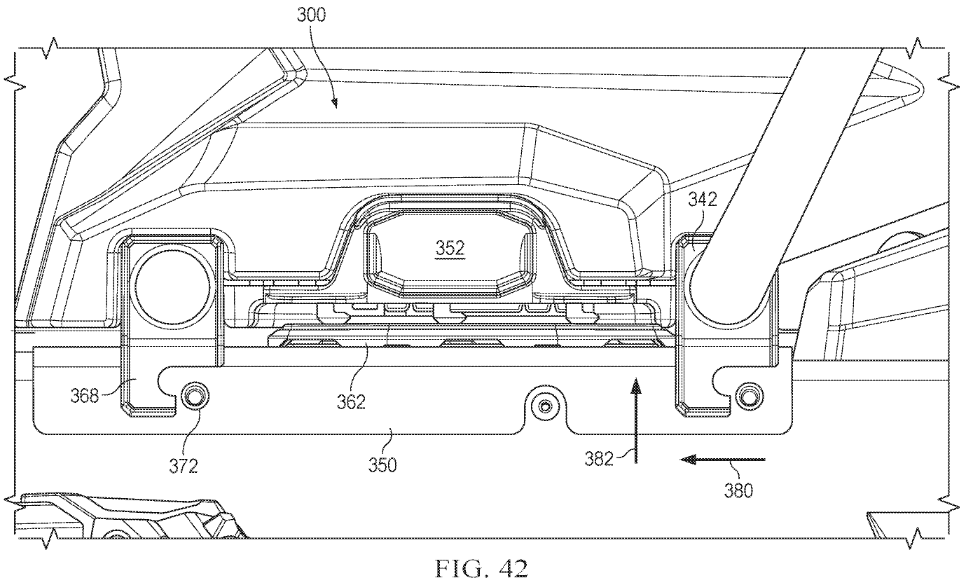

In the embodiment illustrated in FIGS. 41-42, the second member 314 or the end cap 305 positioned thereon includes the flange 368 and the channel 370. In addition to, or alternatively, the first member 312 or the end cap 305 positioned thereon includes the flange 368 and the channel 370. The protrusions 372 are disposed such that the openings to the channel 370 of the first member 312 and the channel 370 of the second member 314 can be aligned with the protrusions so that the protrusions 372 can be received in the channel 370 if the first member 312 and the channel 370 of the second member 314 at the same time. The seat assembly 300 can be moved forward along the tunnel 104 until the protrusions 372 contact the rear channel stop 374 and prevent the frame base 310 from sliding forward. The channel 370 is shaped to slidingly receive the protrusion 372 therein and the rear channel stop 374 can be configured to engage the protrusions 372 and stop the frame base 310 at a location wherein the locking pin 358 of the attachment member 352 is directly over the pin opening 366 of the attachment base 362. This configuration may allow the attachment member 352 to automatically lock into the attachment base 362 when the seat assembly 300 is slid forward to where the protrusion 372 reaches a desired position within the channel 370. Accordingly, the flange 368 may be configured to position and align the seat assembly 300 on the tunnel 104 to allow the hook members 356 to be inserted into the openings 364, 366 in the attachment base 362 when the protrusion 372 is located at the entrance or opening to the channel 370, and to allow the spring-based locking pin 358 of the attachment member 352 to extend into the opening 366 in the attachment base 362 to automatically lock the hook members 356 to the attachment base 362 as the flange 368 is slid forward to position the projections 372 at the desired position in the channels 370 for the attachment member 352 to lock the seat assembly 300 to the tunnel 104.

As illustrated in FIGS. 41-42, the seat assembly 300 may be removed by pushing the release button 360 on the attachment member 352 to withdraw the locking pin 358 from the attachment base 362 and sliding the frame base 310 in a rearward direction (indicated by arrow 380) to simultaneously (1) align the hook members 356 with the openings 364, 366 in the attachment base 362; and (2) align the projection 372 with an opening to the channel 370. The seat assembly 300 may then be lifted in a vertical direction (indicated by arrow 382) to simultaneously remove the hook members 356 from the openings 364, 366 in the attachment base 362 and the projection 372 from the opening to the channel 370.

In some embodiments, the protrusion 372 may be configured to secure the reinforcement bracket 350 to the tunnel 104. The protrusion 372 may be an Allen nut, a socket nut, a stud, a bolt, or a nut. The protrusion 372 may act as a mounting feature that is engaged by the flange 368 to keep the seat assembly 300 secured to the tunnel 104 by itself or in combination with the attachment member 352. In some embodiments, the protrusion 372 may distribute load from the frame base 310 into the side panel 105 of the tunnel 104. As shown in FIG. 43, a fastener 367 inserted from inside the tunnel 104 first through a bracket 365 is connected to the attachment base 362 to removably secure the attachment base 362 to the upper surface of the top panel 103. The protrusion 372 may extend through the side panel 105 of the tunnel 104, optionally through the bracket 365 positioned on an interior surface of the side panel 105, and optionally through the bracket 350 positioned on the exterior surface of the side panel 105. Accordingly, a portion of the side panel 105 may be sandwiched between the bracket 365 and the bracket 350 to provide additional support to the seat assembly 300. A separate component may then be removably secured, optionally threadingly secured, to the outboard end of the fastener to form the protrusion 372. Accordingly, weight from the seat assembly 300 can be transferred to both the top panel 103 and the side panel 105 near the intersection of the top panel 103 and side panel 105 at the edge of the tunnel 104 that is reinforced by one or both of the bracket 365 positioned on the interior of the tunnel 104 and the bracket 350 positioned on the exterior of the tunnel 104.

As shown in FIGS. 45-47, the seat riser 304 of the seat assembly 300 may be configured to integrate and/or mate with the rear panel 234 and the seat 118. The integration promotes the aesthetic look of the seat assembly 300, allows for convenient electrical connections form the battery 232 to the seat assembly 300, and the contours of the seat riser 304 provide structural support for the seat assembly 300. FIG. 46 shows a cross-sectional side view of the seat 118, the rear panel 234, and the seat riser 304. FIG. 46 illustrates how the front contours 384 of the seat riser 304 follow the shape of the seat 118 and rear panel 234 to create a compact fit. This compact fit can be beneficial, as additional accessories may be added to the rear end of the tunnel 104 in addition to the seat assembly 300.

As shown in FIGS. 47, 49, and 51A-52, an electrical connection port 386 may be installed through an aperture 393 defined in the front or side wall of the seat riser 304 that is positioned adjacent to or abuts a wall of the rear panel 234 (such as an inboard wall of the adjacent rearwardly extending legs that defines an opening). The rear panel 234 encloses the rearward facing chamber 230 which may house the starter battery 232 or other electrical components and may be provided with an electrical connection port 396. Therefore, the rear panel 234 provides a convenient electrical connection to the seat assembly 300 that is hidden from view when the removable seat assembly 300 is secured to the tunnel 104. When the seat assembly 300 is secured to the tunnel 104, the opening for the electrical connection port 386 of the seat assembly 300 is automatically aligned with the opening for the electrical connection port 396 of the rear panel 234. In some embodiments, the electrical connection port 396 of the rear panel may automatically pair with the electrical connection port 386 of the seat assembly 300 upon sliding the seat assembly 300 into position on the tunnel 104, and automatically disconnect when the seat assembly 300 is removed from the tunnel 104. Non-limiting examples of a quick disconnect electrical connection include inductive couplers, wherein the transmitter may comprise the electrical connection port 396 and the receiver may comprise the electrical connection port 386.

In some embodiments, the electrical connection port 386 may be used to provide heat to the seat assembly 300 or may be converted into a 12-V or USB outlet. In a non-limiting example, one or more outlets may be provided in the chamber 388 to provide power to one or more personal devices such as cellular phones. In some embodiments, the electrical connection port 386 of the seat riser 304 may connect with a wiring harness 398 configured to carry electrical power to various applications related to the seat assembly 300 (see FIG. 50B). For instance, the wiring harness 398 may carry power to a seat heating element 397 that is positionable in the seat cushion 306, wherein the seat heating element 397 is configured to heat the seat cushion 306 (see e.g., FIG. 51), and in addition to, or alternatively, the wiring harness 398 may carry power to a component positioned on the arm rest 303 such as a hand heating element 552 (see FIG. 56). The chamber 388 of the seat riser 304 may include mounting points and/or surfaces configured to secure the wiring harness 398. In some embodiments, the wiring harness 398 may be routed through the arm rests 303 to the component positioned on the arm rest 303, such as the hand heating element 552.

The seat riser 304 includes the chamber 388 that may be used as an interior compartment that is accessible through the top opening 348 of the seat riser 304 by removing the seat cushion therefrom. The interior compartment may be waterproof and provide the rider with a dry storage space. The chamber 388 may be sealed with the seat cushion frame 390 (see FIGS. 52-53) and the seat cushion 306. In some embodiments, the seat cushion frame 390 may include an elastic seal (not shown) around the perimeter to ensure a waterproof seal. The seat cushion frame 390 and/or the seat cushion 306 may distribute load to the seat frame 302 through the seat riser 304. The electrical connection port 386 can be accessed in the chamber 388 with the seat cushion 306 and seat cushion frame 390 removed.

In some embodiments, the seat assembly 300 may include one or more hand shields 550 and/or electrical components such as a controller positioned on the arm rests 303. As shown in FIGS. 30A-30D, the bracket 321 may be secured to the arm rest 303 that is used to secure one or both of the heated seat controller 333 and the hand shield 550. In some embodiments, the heated seat controller 333 may be configured to control one or more of the hand heating element 552 and/or the seat heating element 397.

An illustrative method of assembling the seat assembly is provided. The method may include one or more of:

providing a seat riser 304 defining a chamber 388 therein; providing a seat frame 302 including a frame base 310 and a seat back frame 318, wherein the seat back frame 318 includes a first end 323 secured to the frame base 310 and a second end 325 extending therefrom; inserting the second end 325 of the seat back frame 318 through an opening in a bottom panel 309 of the seat riser 304 through the chamber 388 and out one or more openings 349 on the top of the seat riser 304 until the frame base 310 abuts an exterior surface of the bottom panel 309 of the seat riser 304; securing a first part of an arm rest 303 to a portion of the seat back frame 318 that is positioned inside of the chamber 388 and securing a second part of the arm rest 303 to the frame base 310 outside of the chamber 388; securing a back rest 334 to a portion of the seat back frame 318 positioned outside of the chamber 388; and removably securing a seat cushion 306 on the seat riser 304 over the chamber 388.

A method of removably securing the seat assembly to a snow vehicle tunnel is provided. The method includes one or more of:

providing a tunnel 104 with a top panel 103 and side panels 105; providing a seat assembly 300 including a first mounting feature engageable with the top panel 103, and a second mounting feature engageable with the side panel 105; and automatically engaging the first mounting feature to the top panel 103 upon engagement of the second mounting feature with the side panel 105. Optionally, the second mounting feature comprises an alignment feature that slidingly engages the side panel of the tunnel. In some embodiments, the first mounting feature includes the attachment member 352 and the second mounting feature includes the flange 368 of the end cap 305.

While the disclosed snowmobile has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment(s) disclosed, but that the invention will include all embodiments falling within the scope of the appended claims.

1. A removable seat assembly, comprising:
a seat frame, including:
a frame base including a front member and a rear member,
a seat back frame coupled to the rear member,
an arm rest comprising a rear support structure coupled to the seat back frame and a front support structure coupled to the front member to provide a first structural support to transfer a load between the front member and the rear member, and
a seat riser positioned on the frame base.

2. The removable seat assembly according to claim 1, wherein the front support structure is received within the front member of the frame base.

3. The removable seat assembly according to claim 2, wherein the seat back frame is received within the rear member of the frame base.

4. The removable seat assembly according to claim 1, wherein the seat riser defines a chamber therein.

5. The removable seat assembly according to claim 4, wherein the seat back frame and the arm rest are at least partially received within the chamber of the seat riser.

6. The removable seat assembly according to claim 5, wherein the front member and the rear member are secured together by one or more base brackets, an attachment member is secured to the base bracket between the front member and the rear member, and wherein the seat riser at least partially houses the attachment member.

7. The removable seat assembly according to claim 1, wherein the seat riser includes a base, a plurality of sidewalls extending from the base to an upper surface that defines an opening to a chamber at least partially defined by the base and the sidewalls, wherein the base is positioned on the front member and the rear member, wherein the seat back frame extends from the rear member through the chamber and upward beyond the upper surface of the seat riser, wherein the rear support structure of the arm rest is coupled to the seat back frame inside of the chamber, and wherein the front support structure is coupled to the front member outside of the chamber.

8. The removable seat assembly according to claim 1, wherein the frame base includes:
one or more first mounting features, the one or more first mounting features including a flange,
wherein the frame base is configured to secure one or more second mounting features, the one or more second mounting features including an attachment member.

9. The removable seat assembly according to claim 8, wherein the one or more first mounting features are configured to removably engage a first mating element disposed on a side panel of a snowmobile tunnel, and the one or more second mounting features are configured to removably engage a second mating element disposed on a top panel of the snowmobile tunnel.

10. A removable seat assembly, comprising:
a seat frame including a frame base;
a seat riser secured to the seat frame, the seat riser positionable on a top panel of a snowmobile tunnel, the seat riser defining a chamber therein, an upper surface of the seat riser defining an opening to the chamber;
a seat removably secured to the seat riser, the seat positioned on the upper surface of the seat riser to cover the opening, and
a mounting feature secured to the seat frame that is removably securable to the snowmobile tunnel.

11. The removable seat assembly according to claim 10, wherein the chamber is waterproof.

12. The removable seat assembly according to claim 10, wherein the chamber is configured to receive an electrical connection port, the electrical connection port configured to provide electrical power to one or more of:
an outlet configured to charge a personal electronic device,
a seat heating element configured to heat the seat, and/or
a hand heating element configured to heat an arm rest.

13. The removable seat assembly according to claim 10, wherein the seat riser includes a recess that houses an attachment member, the attachment member configured to removably secure the removable seat assembly to the top panel of the snowmobile tunnel.

14. The removable seat assembly according to claim 13, wherein the attachment member includes a button configured to unlock the removable seat assembly from the snowmobile tunnel, wherein the button is disposed inboard from an outboard wall of the seat riser.

15. The removable seat assembly according to claim 10, wherein the seat riser includes a bottom surface, the bottom surface including one or more channels to receive the frame base.

16. The removable seat assembly according to claim 10, wherein the seat frame further includes an arm rest and a seat back frame, wherein the arm rest and the seat back frame are received within the chamber of the seat riser.

17. A removable seat assembly, comprising:
a seat frame comprising a frame base and a seat back frame;
a seat riser configured to at least partially receive the seat frame; and
a first mounting feature coupled to the frame base, wherein the first mounting feature is securable to a top panel of a snowmobile tunnel; and
a second mounting feature coupled to the frame base, wherein the second mounting feature is removably securable to a side panel of the snowmobile tunnel.

18. The removable seat assembly according to claim 17, wherein the seat frame further comprises an arm rest including a rear structural support coupled to the seat back frame and a front structural support coupled to the frame base.

19. The removable seat assembly according to claim 18, wherein the seat riser includes a waterproof chamber accessible through a removable seat cushion frame.

20. The removable seat assembly according to claim 19, wherein the first mounting feature is positioned inboard of the second mounting feature, wherein the first mounting feature is at least partially housed by the seat riser, wherein the seat back frame extends from the frame base through a chamber defined by the seat riser and upward beyond the seat riser, wherein the rear support structure of the arm rest is coupled to the seat back frame inside of the chamber, and wherein the front support structure is coupled to the frame base outside of the chamber.

21. A snowmobile comprising:
a tunnel including a top panel extending between two side panels;
a first seat assembly comprising a panel including a rear wall positioned between two rearwardly extending legs; and
a second seat assembly, the second seat assembly comprising a base and a riser positioned on the base, wherein the riser includes a foot extending forward from a front wall, wherein the second seat assembly is removably securable to the tunnel rearward of the first seat assembly with the foot positioned between the two rearwardly extending legs and underneath at least a portion of the rear wall of the panel.
